(19) United States
(12) Patent Application Publication
(10) Pub. No.: US 2025/0118137 A1
(43) Pub. Date: Apr. 10, 2025

(54) GAMING SYSTEM

(71) Applicant: Savvy Dog Systems, LLC, Duluth, GA (US)

(72) Inventor: Brock Smith, Duluth, GA (US)

(21) Appl. No.: 18/911,851

(22) Filed: Oct. 10, 2024

Related U.S. Application Data
(60) Provisional application No. 63/543,401, filed on Oct. 10, 2023.

(51) Int. Cl. G07F 17/32

(52) U.S. Cl. CPC G07F 17/3211; G07F 17/3267

(57) ABSTRACT

Systems and methods to generate and enable use of a skill game. An embodiment of a system may include a processor and a computer-readable storage medium, coupled with the processor, comprising instructions. Upon input from a player, the instructions, when executed by the processor, may initiate play of the skill game, which can include a hexagonal based array of cells having a series of symbols displayed in a presentation order in the hexagonal array of cells. The player must exercise skill to change at least one of the displayed symbols by placing a “wild” symbol in a cell to complete a sequence or pattern of symbols. The instructions can allow for the expansion or modification of the hexagonal based array of cells based on the game instructions and/or based on player election.

### CROSS REFERENCE

The present co-pending application claims benefit from U.S. Provisional Patent Application No. 63/543,401, filed Oct. 10, 2023.

### INCORPORATED BY REFERENCE

The disclosure made in U.S. Provisional Patent Application No. 63/543,401, filed Oct. 10, 2023, is specifically incorporated by reference herein as if set forth in its entirety.

### FIELD OF DISCLOSURE

The present disclosure is generally directed to gaming systems and, in particular, toward gaming systems that enable reconfigurable playfields for skill games.

### BACKGROUND

Gaming machines that offer random-based gambling games or games of chance are prohibited or even illegal in many jurisdictions. Some skill based games do not allow players to win certain amounts, such as, more than the money a player has spent or more than any other player regardless of skill. More recently, electronic skill games have been developed that enable players, though exercise of skill, to win increased amounts or higher value prizes than what the player has input or wagered per play of the game. Traditionally, such games have included multiple reels that have a preset configuration, such as having reels presenting a playfield of 3 rows and 5 columns of symbols. Such playfields, however, generally have fixed configurations of reels and thus fixed sets of paylines for each game. It can be seen that a need exists for gaming systems that address the foregoing and other related and unrelated problems in the art.

### SUMMARY

According to various aspects of the present disclosure, Applicant has recognized a need for gaming systems and methods for enabling presentation of skill-based games, such as electronic skill games, that can incorporate varying and reconfigurable playfields of electronic skill games, including the ability to change and/or reconfigure the playfields of such skill games, including changing the presentation of different numbers and configurations of reels (e.g., different numbers of rows and columns such as by adding or removing reels with different numbers of symbols and/or creating differing offset arrangements of symbols in such rows and columns) to create different playfields and different numbers of winning paylines for an individual game, without having to create a new game to provide for a change in the number of reels.

In some aspects, the gaming system can be configured with programming or instructions that, when executed, enable one or more controllers or processors of the gaming system to change or reconfigure the playfield presented on a display of the gaming system. For example, in some embodiments, the gaming system can be configured to present a bonus game as a subgame within a skill game being played, which can have a changed playfield with more or less numbers of rows and columns of symbols, and which can require the player to use skill to perform different actions from those required to play and/or win the main skill game being played.

In addition, according to other embodiments, the gaming system can be configured to present different, changing playfields with different rows and columns based on a level of play of the skill game. For example, if the player wagers a higher amount, or has reached a certain play level based on their exercise of skill, a different playfield for such a different play of the skill game (e.g., higher cost level), with different numbers of potential paylines, can be generated and presented by the gaming system.

Such gaming machines may offer a number of built-in game play features that contribute to the overall player experience. Any type of game play feature that presents the player with additional challenges whereby they can interact with the game (as opposed to relying on luck) and have more opportunities to win is often viewed as desirable and can lead to increased play of the gaming machine.

According to some aspects, the present disclosure relates to a device, method, and system that can comprise an electronic skill game configured such that a player can be presented with a challenge that, when solved by the player based on their exercise of skill in manipulating a series of symbols, capturing targets, or other actions, can enable the player to not only win the game, but achieve higher value prizes. For example, in embodiments, the electronic skill game can be configured with multiple correct winning solutions or sequences, and to achieve a higher value win (e.g., a win with a greater return than the player's play value for the game), the player is tasked with finding a most correct winning sequence.

In certain embodiments, the present disclosure relates to a gaming system, method, and gaming devices (e.g., a gaming terminal, tablet, phone or other device configured to enable play of electronic games) that provide selectable symbol operations for electronic games, for example, skill games. In embodiments, the gaming system can include gaming devices configured to present and enable play of grid-based (e.g., multi-reel, wild selection and/or matching) games. In some embodiments, grid can include a playfield configured with series of cells arranged in rows and columns.

In addition, in embodiments, the gaming system can be configured to present games comprising playfields having multiple “reels” arranged to provide a plurality of different configurations of cells. For example, in various embodiments, the cells can be configured with a hexagonal shape (or other shape that enables the cells to nest or otherwise fit together), and can be arranged/positioned in offset rows and/or columns. Moreover, in embodiments, additional rows or columns can be added, such as by adding additional reels of 1, 2, 3, 4, 5, or potentially more selectable symbols adjacent one or more existing reels, which can create additional winning combinations and enable the presentation of variable playfields.

In embodiments of the gaming system and for operation of the methods according to various aspects of the present disclosure, a gaming device is provided. The gaming device may comprise a display device; a processor coupled to the display device; and a memory coupled with and readable by the processor and storing therein programming or instructions that, when executed by the processor, cause the processor to execute operations for playing a game (e.g., in embodiments, a skill game). The operations or instructions, when executed, may include receiving a first input (e.g., a play request) from a player interacting with the gaming device initiating a first play of a game. In an embodiment, the first play or first input may include entry of a command or an indication to start or begin the game or a round or play of the game (e.g., the player can push a button, etc.).

In addition, in some embodiments, the player can be required to input some type of credit and select a play value per play of each game.

In embodiments, the game may include a field that can be arranged as an array of cells (e.g., a grid) having a presentation order defining a specific position of each cell in the array of cells relative to one another. The gaming device further can include programming configured to run operations or instructions for the game that, when executed, may include rendering, by the display device in response to receiving the first input/play request, a first sequence of symbols can be presented, which can, in embodiments, comprise a series of reels (e.g., 3, 4, 5, etc.) creating an array of cells arranged in a hexagonal pattern of offset rows and columns, with each cell in the array of cells comprising a discrete symbol in the first sequence of symbols. The operations or instructions, when executed, may include receiving a symbol selection input from the player interacting with the gaming device, such as by the player touching or otherwise selecting a particular symbol in the rendered first sequence of symbols from at least a first cell in the array of cells to become a “wild” symbol to form at least a second sequence of cells (e.g., at least one winning sequence or a losing sequence of same cells arranged in-line along a payline).

In addition, in some embodiments, the operations or instructions can be configured such that, when executed, enable multiple winning paylines to be generated depending on the “wild” symbol selection, and/or enable multiple different value winning sequences to be created by a “wild” symbol selection, with the player being tasked to use skill to select a particular symbol to make a “wild” symbol in or to achieve a best or highest value winning sequence and award.

In addition, in some embodiments, the player can continue to play the game without “cashing out,” e.g., they may still have credits or may leave their winnings as credits to continue playing the game. In such instances where the player continues playing the game, the operations or instructions, when executed, may include receiving a second play request or input from the player interacting with the gaming device that initiates a second or next play of the game. In response to receiving the second input, a new or second sequence of symbols can be generated within the array of cells. In an embodiment, the second input may include an indication to start or begin a next or second round or play of the game, or a request for a play of a different level or bonus game of the current game, or a different selected skill game. The operations or instructions, when executed, further may include determining, based on a position of the particular symbol selected as the “wild” symbol and a position of each symbol in the first or second sequence (and, in other embodiments, subsequent sequences) of symbols relative to the presentation order, a game outcome of the second play of the skill game.

In some embodiments, a method is provided. The method may include receiving, by a processor of a gaming device, a first input (e.g., a play request) from a player interacting with the gaming device initiating a first play of a skill game, the skill game arranged as an array of cells having a presentation order defining a specific position of each cell in the array of cells relative to one another. The method may include rendering, by a display device of the gaming device in response to receiving the first input, a first sequence of symbols is populated into the array of cells, each cell in the array of cells comprising a discrete symbol in the first sequence of symbols. In embodiments, the method may include receiving, via a user interface of the gaming device, a symbol movement input from the player interacting with the gaming device for selection of a particular symbol in the rendered first sequence of symbols in the array of cells to become a “wild” symbol to create/provide a second sequence of cells.

In some embodiments, the method may include determining, by the processor of the gaming device based on a position of the selected “wild” symbol and a position of each other symbol in the first sequence of symbols relative to the presentation order, a game outcome of the first play of the skill game (e.g., whether the player created a winning sequence, and, in embodiments, if a best winning sequences was achieved and/or what value winning sequence was created). In embodiments, the method also may include receiving, via the user interface of the gaming device, a second input (e.g., a second play request) from the player interacting with the gaming device that initiates a second play of the skill game. The method may include rendering, by the display device of the gaming device in response to receiving the second input, a second (e.g., a different) sequence of symbols populated into the array of cells. In another embodiment, the method may include receiving input from further player interaction, such selection of a particular symbol to become a “wild” symbol in the second sequence of symbols. The method may also include determining, by the processor of the gaming device based on a position of the selected “wild” symbol and a position of each symbol in the second sequence of symbols relative to the presentation order, a game outcome of the second play of the skill game.

In some embodiments, a system is provided. The system may include a processor and a computer-readable storage medium, coupled with the processor, comprising instructions that are executable by the processor. The instructions, when executed, may comprise instructions that initiate a first play of a game. In some example embodiments, the skill game can comprise a grid based game that can include a game field arranged as an array of cells having a presentation order defining a specific position of each cell in the array of cells relative to one another. The instructions, when executed, may comprise instructions that, in response to receiving the first input, cause a first sequence of symbols to be rendered in an array of cells, each cell in the array of cells comprising a discrete symbol in the first sequence of symbols. The instructions, when executed, may comprise instructions that receive a “wild” symbol selection input in the rendered first sequence of symbols. The instructions, when executed, may comprise instructions that, based on a position of the selected “wild” symbol and a position of each symbol in the first sequence of symbols relative to the presentation order, determine a game outcome of the first play of the skill game.

Still other aspects and advantages of these embodiments and other embodiments, are discussed in detail herein. Moreover, it is to be understood that both the foregoing information and the following detailed description provide merely illustrative examples of various aspects and embodiments and are intended to provide an overview or framework for understanding the nature and character of the claimed aspects and embodiments. Accordingly, these and other objects, along with advantages and features of the present disclosure herein disclosed, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain the principles of the embodiments discussed herein. No attempt is made to show structural details of this disclosure in more detail than can be necessary for a fundamental understanding of the exemplary embodiments discussed herein and the various ways in which they can be practiced. According to common practice, the various features of the drawings discussed below are not necessarily drawn to scale. Dimensions of various features and elements in the drawings can be expanded or reduced to illustrate the embodiments of the disclosure more clearly.

FIG. 1A depicts one example embodiment of a computational gaming device for enabling enhanced gaming features and operations in accordance with the principles of the present disclosure.

FIG. 1B depicts another example of a computational gaming device for enabling enhanced gaming features and operations in accordance with the principles of the present disclosure.

FIG. 1C depicts an example embodiment of a playfield in accordance with the principles of the present disclosure.

FIG. 2 is a block diagram depicting an embodiment of components of a computational gaming device for enabling enhanced gaming features and operations in accordance with the principles of the present disclosure.

FIG. 3A illustrates an example embodiment of an 2-3-2 array of hexagonal cells of a skill game on a hexagonal game grid having n columns and n hexagonal cells per column.

FIG. 3B shows an example embodiment of an illustrative layout of symbols rendered to an 2-3-2 array of hexagonal cells of a skill game in accordance with the principles of the present disclosure.

FIG. 3C show examples of pay-line layouts for the skill game of FIG. 3B.

FIG. 3D shows an example embodiment of an illustrative layout of symbols rendered to an 3-4-3-4-3 array of hexagonal cells of a skill game in accordance with the principles of the present disclosure.

FIG. 3E show example embodiments of payline layouts corresponding to various different winning sequences or combinations for a skill game with a playfield including a hexagonal array of cells as shown in FIG. 3D, in accordance with the principles of the present disclosure.

FIG. 4A illustrates the example embodiment of an 2-3-2 array of hexagonal cells of a skill game of FIG. 3B and shows a first output of the computational gaming device showing a first sequence of symbols comprising a selectable “wild” symbol feature associated with a particular symbol in the array of hexagonal cells that are rendered as a result of a play of the skill game in accordance with the principles of the present disclosure.

FIG. 4B illustrates an example embodiment of a second sequence during play of a skill game on the computational gaming device, illustrating creation of a winning sequence of symbols in an array of hexagonal cells by selection of a “wild” symbol, in accordance with the principles of the present disclosure.

FIG. 4C illustrates an example embodiment of a third sequence during play of a skill game on the computational gaming device, illustrating creation of a winning sequence of symbols in an array of hexagonal cells by selection of a “wild” symbol, in accordance with the principles of the present disclosure.

FIG. 5 illustrates an example embodiment of a further output of the computational gaming device showing a pop-up window comprising subsequent play information in response to selection of a “wild” symbol of one of the symbols of the array of hexagonal cells in accordance with the principles of the present disclosure.

FIG. 6 is a flow diagram depicting a method of an example process for enabling the gaming system to reconfigure the playfield is shown in accordance with embodiments of the present disclosure.

FIG. 7 is a flow diagram of an example process for determining subsequent play information associated with performing a “wild” symbol selection operation in the skill game in accordance with the principles of the present disclosure.

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a reel” can include two or more such reels unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It should be appreciated, that as used herein, terms of approximation, such as a “about” or “approximately,” refers to being within 10% margin of error.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “can,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular embodiment.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed but are used merely as labels to distinguish one claim element having a certain name from another element having a same name (but for use of the ordinal term) to distinguish claim elements.

Disclosed are components that can be used to perform the disclosed methods and systems. These and other components are disclosed herein, and it is understood that when combinations, subsets, interactions, groups, etc. of these components are disclosed that while specific reference to each various individual and collective combinations and permutation of these cannot be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems can be understood more readily by reference to the following detailed description of preferred embodiments and the examples included therein and to the Figures and their previous and following description.

Embodiments of the present disclosure are directed to an amusement or gaming system or machine that facilitates play of skill-based electronic game(s) (also referred to as a “skill game” and a “game”) that allow players to spend money and win awards including money, prizes, credits, or other rewards by exercise of skill, including winning awards (e.g., higher value prizes) greater than a player's amount spent through the exercise of such skill. Effectively, a player's ability to win a prize or award is dependent on their exercise of skill, for example, learning and executing rules, patterns, and other features of the game as opposed to random chance or “blind luck.”

For purposes of illustration, and not limitation, embodiments of the amusement system of the present disclosure will be described in connection with amusement systems or gaming devices that can be configured to provide one or more skill games that can incorporate a “wild” symbol selection operation. For example, a player during play of a game can select at least one symbol (such as, for example, characters, icons, or other indicia) positioned at a particular location on a game field of a skill game to turn the selected symbol into a “wild” symbol that completes a winning sequence or solution to a puzzle presented by the game field (e.g., the selected “wild” symbol relative to the locations of other symbols or a same type on the game field completes creates an alignment of a series of same symbols in a line to solve and win the game).

In embodiments, the gaming system and methods of the present disclosure enable the creation of varying playfield configurations that can enable the formation of increased numbers of paylines, and further can enable the creation of varying arrangements of playfields by the gaming system, using a base hexagonal arrangement of cells to which additional cells (e.g., additional rows and/or columns, and in some embodiments, individual cells can be added to change the game configuration) that, upon selection of a particular “wild” symbol can allow a player to, by exercise of a level of skill, generate more than one winning sequence of symbols to win the game being played.

In addition, in embodiments, the game can be configured to enable multiple winning sequences or correct solutions. If the player is able to play the game better (e.g., by exercise greater skill) and create/determine a more correct, or the most correct winning sequence, the player can win a greater award. For example, the game can be configured to present various differing playfields (e.g., different configurations of rows and columns wherein rows or columns, or even some individual cells can be added or removed) based on the design of the game, type of game, award value selected by the player, skill level of the player, or other factors, or combinations thereof, that enable multiple winning sequences, and it is up to the player to find the most correct winning sequence to win the highest value prize.

Still further, in some embodiments, during each play of a selected skill game, a play time may be generated based on various factors (for example, difficulty, potential winning amount, and/or symbols currently on the game field, among other factors). The duration of each play may be the total allotted play time for a game. In other words, in embodiments, the player can be presented with a different available time or duration of play time to select a “wild” symbol to create a winning sequence or alignment, or, in embodiment, a best winning sequence out of multiple different potential winning sequences. In some embodiments, the skill game can be configured to enable multiple plays, e.g., multiple successive puzzles or a bonus game can be permitted within the allotted play time based on player skill and/or a selected wager or game feature.

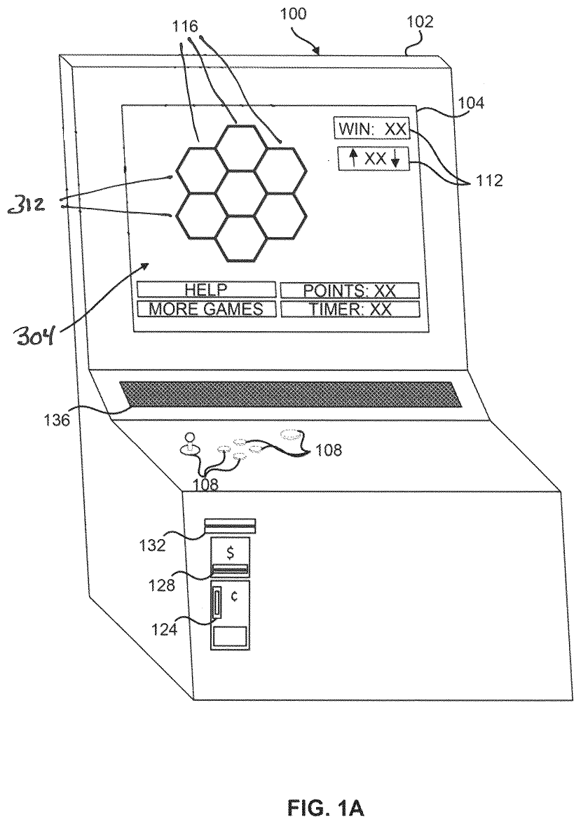

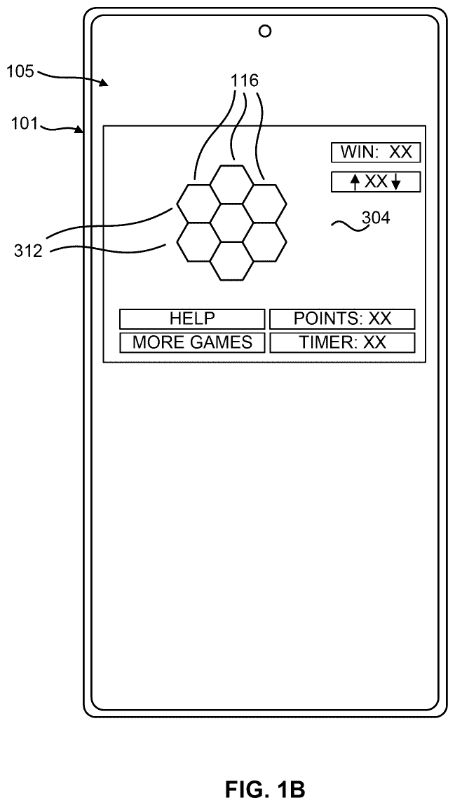

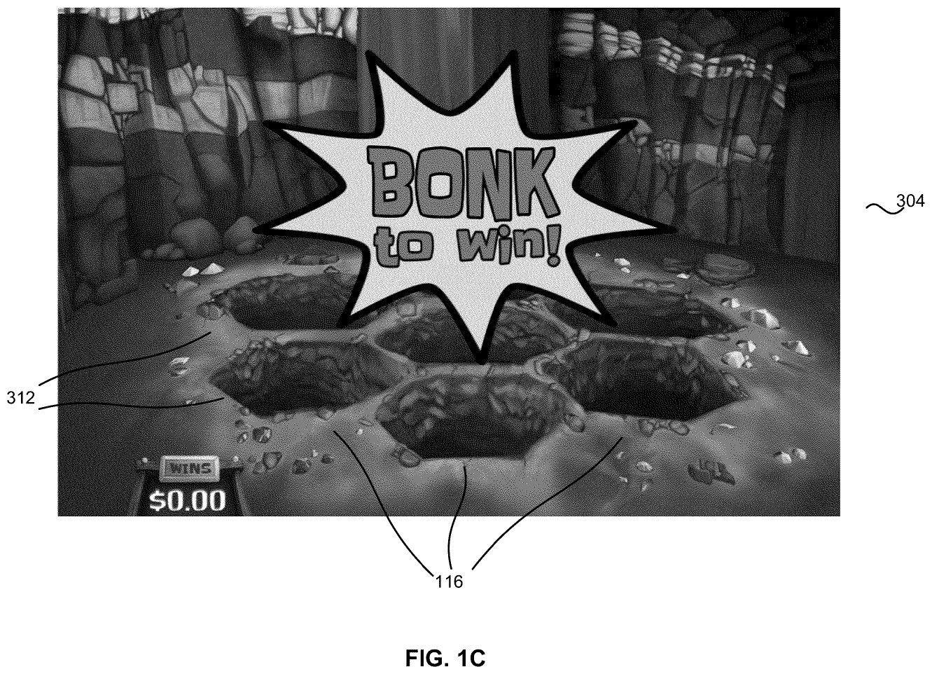

In embodiments, as illustrated in FIGS. 1A through 7, the amusement system can comprise an electronic skill game. By way of example only, in embodiments, the amusement system can include a gaming cabinet or housing such as shown in FIG. 1A that supports a display (for example, a flat panel display or monitor) with a screen for display of one or more game fields and/or images and for supporting play of one or more skill games.

In embodiments, the display can comprise a touch screen having on-screen player controls that enable a player to touch and drag selected symbols across the screen during play. In some embodiments, the gaming cabinet further can include other types of game or player controls (for example, buttons, joysticks, directional pads, and/or levers, among other types of player controls) that allow individual users or players to play different types of skill game(s) and control and/or select various corresponding gaming elements or features shown on the display.

In addition to controlling play of games, the player controls can be used to control and/or select other functions of the games. For example, buttons, icons, symbols, and so on can be provided to enable players to change the amount of cost or credit used per play. For example, players can cycle or toggle through a predefined list(s) of play costs shown on the playfield to set play values for each individual game, and, in some embodiments, values for different game solutions. Still further, the player controls can include buttons such as a menu/change game button to enable the player to exit and/or change the displayed game, or to open or otherwise initiate a “Menu” or “Help Screen” and/or other informational features of the amusement system.

In embodiments, the gaming cabinet further can include one or more monetary interface peripherals (for example, a bill acceptor, printer, and/or other similar peripherals). The bill acceptor can accept valid notes of currency, such as bills or coins, that are converted to credits at the individual player stations. The printer can provide printouts, receipts, and/or vouchers that record or provide payment or payout information, prize redemption tickets, as well as other suitable information, such as audit conformation and reports.

In addition, in embodiments, the gaming cabinet also may include audio and lighting features/elements (for example, speakers or other audio producing transducers and LED lighting elements, and/or lightbulbs, among other elements) that provide various audio, visual, tactile or other effects in concert with or otherwise corresponding to game play. In some embodiments, the gaming cabinet further can include an optional, secondary video display (such as, a light up display or a video display, including, for example, a liquid crystal display (“LCD”), a cathode ray tube (“CRT”) display, a light emitting diode (“LED”) display, and/or a plasma display) provided there along, such as along an upper or top portion or area of the gaming cabinets. The secondary display may show any combination of game information, ancillary information, or other related information to the players, such as player information, bonus information, advertisements, and/or selectable game options.

It will further be understood that, while embodiments of the present disclosure may be described in connection with the example of a single player cabinet game or touch screen type gaming device for play of skill-based games, it should be appreciated that embodiments of the present disclosure are not so limited. For instance, as indicated in FIG. 1B, other types of computational devices, such as portable user devices, smartphones, tablets, laptops, Personal Computers (PCs), and/or wearable devices may be used to implement game enhancement features as part of a game as described herein.

Furthermore, it should be appreciated that embodiments of the present disclosure may apply to games other than skill-based games. For instance, and not limitation, embodiments of the present disclosure may be used in connection with any type of grid-based skill game such as bingo, keno, slots, other types of matching games, and in some embodiments, slidable or movable symbol type games (e.g., “Line-Up” type games wherein a player can select and move or drag a symbol to a new position during play), and/or table games.

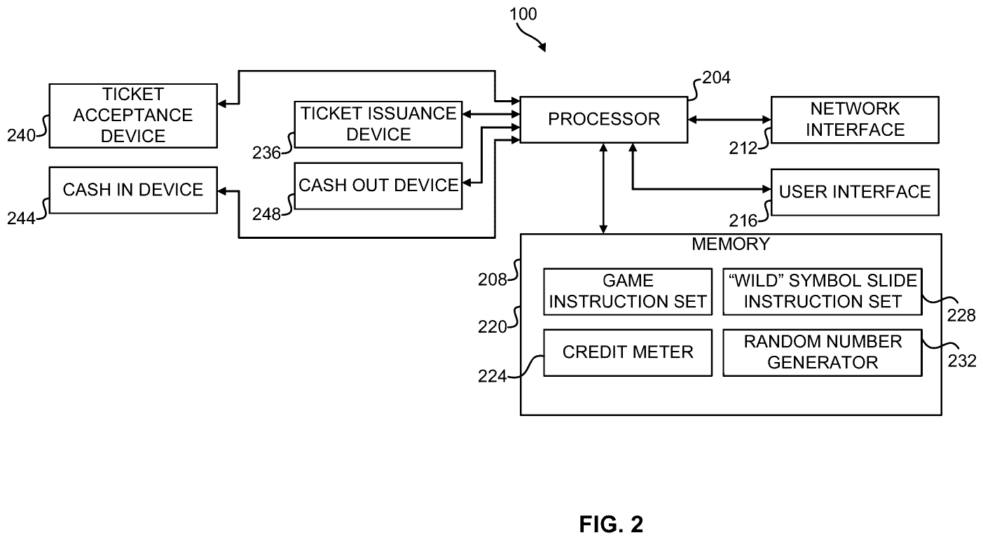

In one embodiment, as indicated in FIG. 2, the amusement or gaming system can include a centralized or host control system having one or more processors (for example, microprocessors, CPUs, and/or other processors) that is in communication with the individually connectable or linkable player stations, which each can have their own player station control systems, with one or more processors in communication with the centralized control system. The player station control systems communicate or cooperate with the centralized control system to send and receive instructions, feedback, workflows, and/or signals to facilitate game play and other functions of the amusement system. Each of the player station control systems generally controls and provides processing of one or more actions of its corresponding game controls and monetary interface peripherals, as well as the audio and lighting features of the player station. The player station controls also can provide tactile or haptic feedback during game play.

The centralized control system and the player station control systems access, run, and coordinate action of one or more actions or components of a gaming platform that provide for play of one or more skill-based games with the amusement system. The amusement system further will include or provide skill-based games with prescribed operations or patterns incorporating a series of learnable skill applications/features, operable without the use of Random Number Generators (RNGs) or other randomized, compensation algorithms, and/or automatic awards algorithms that introduce “chance” into the game or otherwise limit the player's exercise of skill or ability to win a game. For example, the games can include an environment of changing screens, colors, characters, elements, and/or features which can provide the appearance of randomness, but also include rules and identifiable patterns that a player can learn or strategize against to develop their skill and ability at playing the game to consistently attain awards greater than the amount the player has spent (or a greater than I 00% Return to Player (“RTP”)).

The centralized control system can include one or more processors (including microprocessors, CPUs, and/or other processors), and one or more memories (including ROM, RAM, and/or other non-volatile memories) that store instructions, including game rules and/or instructions and other programming, that when accessed and executed by the one or more processors facilitate game play and other operations/functions of the amusement system.

In one example embodiment, the centralized control system includes a centralized PC system controller with at least one processor and a memory; however, other suitable computing hardware can be used without departing from the scope of the present disclosure. The centralized control system further can include a graphics adapter, or a connector configured to accept a graphics card. Still further, the centralized control system can include one or more hubs, such as one or more USB port hubs that connect to one or more controllers of a motherboard of the player station control systems 64.

In one embodiment, the gaming platform can provide a video playfield on the display of the gaming cabinet. The playfield may be used by one or more players (e.g., by accessing the controls of a corresponding player station) to compete for awards or prizes that are made available over time. The awards or prizes can include or otherwise be associated with one or more symbols or sets of symbols (e.g., graphic icons, characters, numbers, and/or other symbols) each arranged in a grid-style pattern that allow players to select one or more of the symbols, characters, and/or numbers in one or more of the cells to create a “wild” symbol to form one or more winning sequences or correct solutions to the game.

In embodiments, the gaming platform further can be configured to award a prize based on the highest winning sequence or correct solution created by the player. In addition, in some embodiments, the gaming platform can be configured (e.g., include one or more processors executing programming or instructions to determine if the player has created/made a player selected sequence of a series of adjacent same type symbols and the wild symbol that matches one or more winning sequences, and which player selected sequence achieves a best or highest value award per play. Still further, in some embodiments, the gaming platform can include programming or instructions configured to prompt the player to keep working to find the best winning sequence or solution for the game. For example, the player can have a selected time to play and win the game, and if the time has not expired, the player can be prompted to keep playing if a winning sequence or solution, or if the best solution, has not been achieved.

In embodiments, the game grid can comprise a “reel” type game having a game grid with a plurality of rows and columns. For purposes of illustration, the game grid is shown in the illustrated example embodiments and including a series of hexagonal shaped cells arranged in offset rows and/or columns. The cells further can be arranged to create a generally hexagonal grid, or in other configurations. The example embodiments will hereafter be referred to as hexagonal cells as shown in the figures, but it will be understood by those skilled in the art that the present disclosure includes various other configurations of cells and game grids, and is not limited to hexagonal cells and grids.

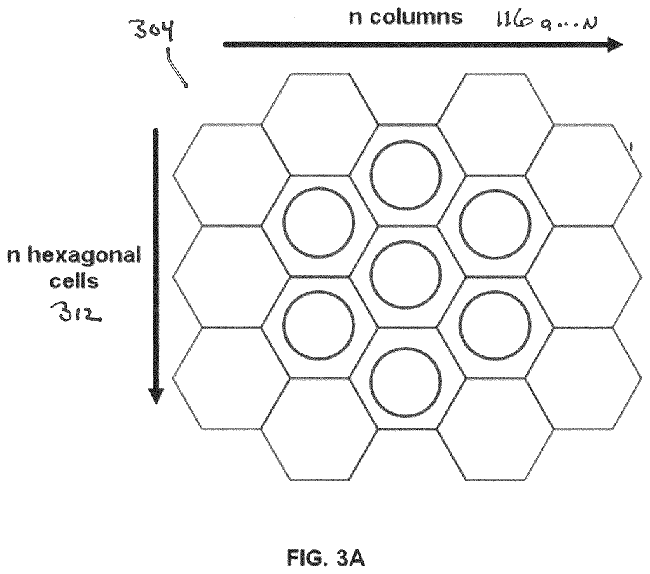

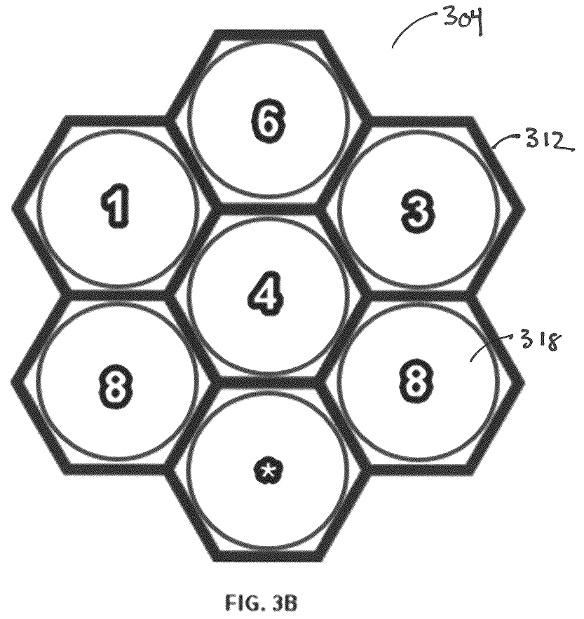

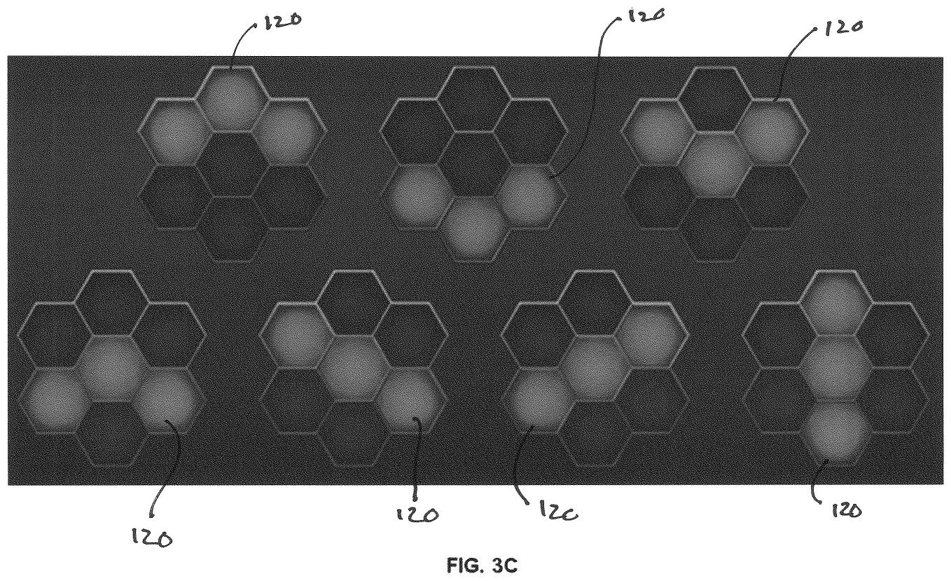

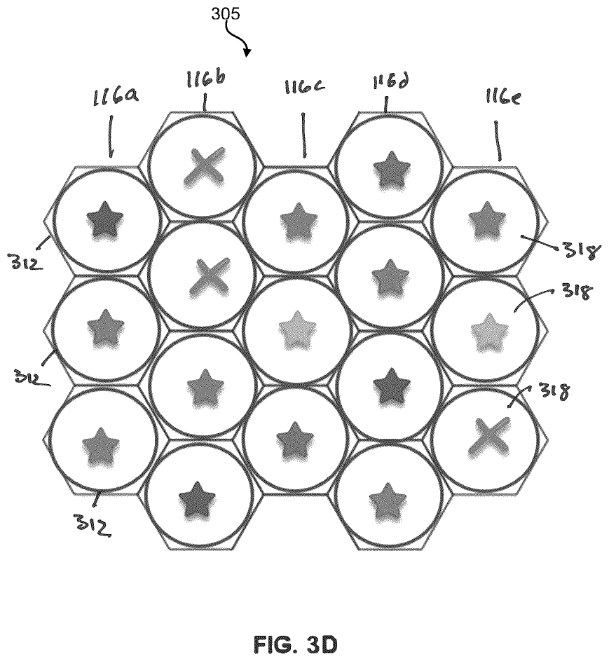

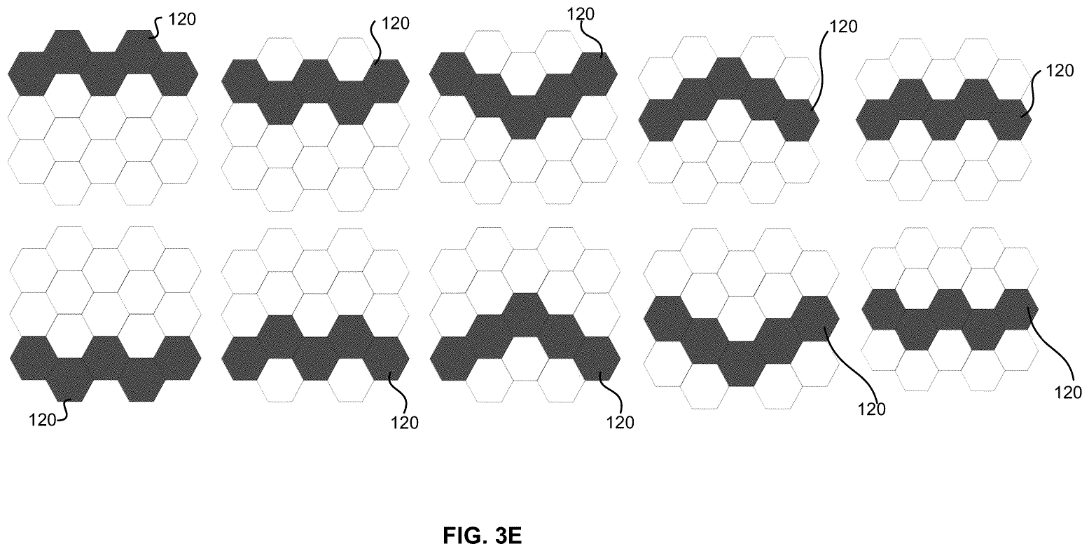

As shown in the attached figured, in embodiments, it is contemplated that the game can include a hexagonal game grid that can comprise a plurality of adjoining columns (n columns), in which each column has a plurality of stacked adjoining hexagonal cells (n stacked cells) as shown in FIG. 3A and which, in embodiments, can be expanded to create an enlarged grid array in game play. In use, actions can include a plurality of repetitive motions and/or pattern recognition that can be learned, recognized and anticipated by player skill and experience.

In embodiments, the symbols further can have differing appearances, values, and difficulty levels of attainment. Generally, a selected time frame and/or distance to generate a winning payline, which can include a select number of adjoining symbols on the respective hexagonal cell, can be used to generate or create a more difficult to obtain winning payline, can have a higher potential award or prize values. In one variation, derivations in size of different symbol types can be used as lower-value and higher-value types of symbols. In other variations, sequentially increasing numbers and/or letters may be utilized as lower-value and higher-value. As a result, the skill of the players (e.g., their decision making, ability to take certain actions quickly, ability to recognize and/or learn patterns, learn and/or memorize game instructions or rules) and their knowledge of the conditions of the game will determine immediate and long-term outcomes (e.g., awards, prizes, winnings, and/or bonus pools). Therefore, it is possible for skilled players to attain outcomes/award values that result in a consistently greater than 100% RTP over time, and with outcomes based on chance and/or which are predetermined being substantially eliminated.

The amusement system also includes one or more gaming platforms or gaming programs that include programming or instructions for one or more skill-based games. The gaming platform can include computer programs instructions, workflows, and/or code that are accessed and executed by the processors to facilitate play of the one or more skill-based games with the amusement system. In additional or alternative constructions, however, the gaming platform(s)/program(s) can be accessed and/or run on one or more personal electronic devices, such as smart phones, tablets, personal computers, and/or other mobile electronic devices, to facilitate play of the one or more skill-based games on the personal electronic devices.

In one embodiment, the personal electronic devices can be provided at a facility (for example, amusement center, gas station, grocery store, airport, and/or other similar locations) and accessed by players for play of the one or more skill-based games, and in other embodiments, players can access and/or download the gaming platform(s)/programs (such as from an application store, for example, Apple Store®, Google Play® store, and/or from an available public or private network) to their own personal electronic devices for play of the one or more skill-based games therewith. In the embodiments employing personal electronic devices, the player controls can be provided as selectable icons or areas shown on the display of the personal electronic devices and/or can include physical controls of the devices themselves and/or remote controls in communication therewith.

The gaming platform can provide one or more substantially true skill-based games that do not utilize a Random Number Generator (RNG) and/or compensating algorithms for a player to “win the game,” such as may be common with many “slot” games and other “games of chance.” That is, players generally control decisions on whether or not to take specific actions (for example, direct objects, initiate game plays, set play costs, and/or make selections, among other actions) at any particular time and player skill abilities and/or player strategy determine immediate and long-term outcomes. In embodiments, no aspects of the skill game that affects the ability of a player to win/solve the game and to be awarded an award or prize are RNG driven, and no background code runs (for example, compensation algorithms) that calculate and/or artificially limit the return to a player and/or make it difficult for players to attain awards or prizes regardless of their skills. The gaming platform generally includes programming requiring interaction and the application of player skill and/or strategy to obtain awards or prizes.

For example, in embodiments, one or more skill-based games use multiple screens or multiple elements and/or features provided on the display of the amusement system to give the appearance of chance or randomness, though the screens, features, and/or elements are not provided at random, and instead are provided according to prescribed or predetermined patterns or with specific tendencies that can be learned or memorized by players such that players can win based on their individual skill. That is, all choreography, awards/prizes, and/or odds of attainment are deterministic, predictable, and/or pattern-based for potential memorization and/or anticipation by players.

In some variations, help text can be provided to players within the game's help screens (for example, accessed via the menu button) to help players understand the game and/or develop strategies. As a result, players are able to use skill to win more than spent over time (in other words, players can have more than 100% return to player percentage (“RTP”) over time). Return to player generally includes an amount awarded to a player over an amount or value spent by the player towards the award. That is, an amount or value expended by the player to obtain the award. In this regard, by understanding the rules and game operations and using strategies and tools available during gameplay, it is possible for players to attain awards or prize values, by exercising of skill, that result in a consistently greater than 100% RTP over time.

In an embodiment, the array or arrangement of symbols or elements displayed within the game field or playfield by the amusement system may appear to be randomly generated. If no winning combination is possible based on this initial play, the player must select at least one element to continue play of the game (e.g., turn a symbol into a “wild” symbol), or, in some embodiments, can press a button or icon to request a generation of a new field of cells. In such an embodiment, the amusement system may, for the same play, generate a new arrangement of symbols or elements (in other words, a player can continue to generate new playfields or arrangements of symbols or elements, at least for the time set to win the game or play or solve a puzzle). In embodiments, the player can request such a new game field, but may lose part of their play value, or can be given an option to reduce the play value in exchange for the new game field.

In an embodiment, the amusement system may include sub-games defined by a series of game instructions or rules stored in the memory and accessible by players at the player stations; receive a cost for a play of the skill-based game from one or more active player stations; receive one or more game play input signals from one or more player controls of an active player station, and in response, directing one or more objects along the playfield or, in particular, a grid-style playfield; and if one or more objects are aligned in a column or row of the game, initiate a bonus game or a sub or meta-game associated with the one or more symbols and determine whether one or more of the active player station has obtained an award based on game rules or instructions related to the sub or meta-game associated with the one or more symbols. Players at the player stations can use strategy or skill to direct objects at select ones of the plurality of symbols to achieve a return to the player greater than 100%.

The game(s) can include several symbol types, with derivations in size, color, and/or appearance and/or a time or timer based on lower-value symbols and higher-value symbols (for example, some symbols, if those symbols include a potential match or alignment, may generate an increase or decrease in time for a player or user to make a match or alignment).

For example, in embodiments, the symbols or objects could include pictures, animated characters, sequentially numbered symbols, such as numbered balls, etc. and by increasing the number of cells in the array presented on the playfield, the difficulty, and thus the value or amount winnable by a player, may be determined based on a greater number of symbols of a same type (including the “wild” symbol) aligned in a column, staggered row, diagonal or other arrangement, and/or based on the amount of time available to align a set of symbols in a winning payline. In such embodiments, the amount of time available to make a match or alignment may also be based on creating a winning sequence of a highest value or numbered symbols displayed on the table that could be aligned in a winning payline (e.g., using billiard balls as an example, the higher the number on the billiard balls, such as 15 balls, 8 balls, etc . . . , the greater the win).

In addition, while an example embodiment of a skill-based game is discussed and shown in the figures using a game or play field having hex shaped cells with numbers as the symbols shown in a hexagonal array, it will be understood that such an example is non-limiting, and, rather than balls, other symbols or objects may be utilized, such as, for example, numbers, letters, and/or other objects or symbols (for example, rubber ducks, animals, different types of candy or fruit, and/or other various objects) or symbols. Still further, in some embodiments, the symbols can be provided with different effects, such as flashing colors, changing size, highlighting or shadowing, and/or other animation effects, e.g., ducks flying, fruit peeling, etc.

In exemplary embodiments, the games displayed/presented by the amusement system can include reel based grid-type games, which can include a series of reels that create different sets of rows and columns of cells or positions of symbols. For example, traditional “8-up” games can have a series of reels with 3 columns and 3 rows, creating a generally square or rectangular configuration.

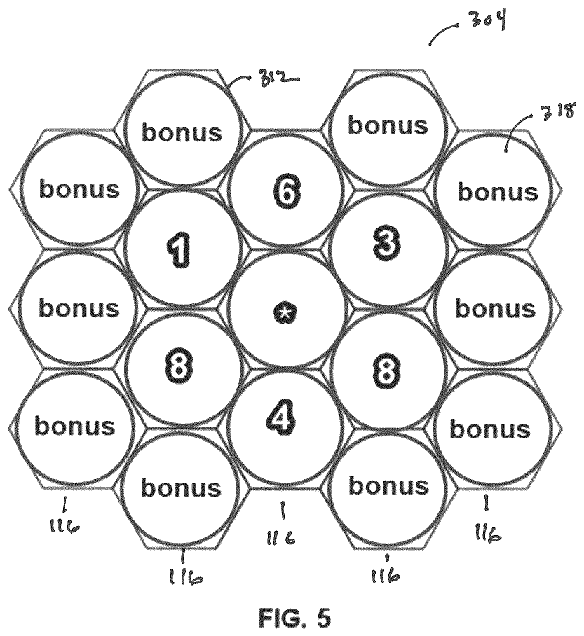

In embodiments of the gaming system or platform and methods of the present disclosure, a series of reels can be provided, and configured to present a game or playfield with a plurality of cells, with various symbols positioned therein, arranged in various hexagonal based grid arrays, which are configured to present the cells in offset rows and/or columns. For example, such hexagonal based grid-type arrays can include a 2×3×2 (as shown in FIGS. 1C and 3A-3B), 3×4×3, 3×4×3×4×3 (as shown in FIG. 5), 2×3×4×3×2, 4×5×4×5×4, and/or other varying size configurations depending on the number of reels. Further, in examples, the gaming system can include programming or instructions configured to provide an ability to change or expand the hexagonal based grid during or as a result of game play, e.g., initially starting the game as a 2×3×2 hexagonal based grid array (as shown in FIG. 3A) and generating an expanded game field (such as, for example, a 3×4×3×4×3 grid array, as shown in FIG. 5) as a result of game play or selected game play options.

For example, in embodiments, during play of the skill game, the player can be at least initially presented with different variations of the play field starting with a base 2×3×2 hexagonal playfield such as shown in FIGS. 1C, 3A and 4A-4C. In embodiments, the one or more processors of the gaming system 100 (FIG. 2) can further include programming or instructions configured to enable the gaming system or platform to create new, varied and different playfield.

In some embodiments, the one or more processors of the gaming system can include programming or instructions configured to present the player with a bonus game if the player has achieved some play level, or as a prize for playing. The bonus game can comprise a subgame that allows the player to win a prize (e.g., extra plays, a value multiplier, etc.) without having to place a wager to play. The bonus game can presented with a game field or playfield with a similar array of cells in a hexagonal arrangement (at least as a starting point), or can present a playfield with additional cells to create additional rows and/or columns, and/or add or remove cells from existing rows of columns of the array, such as shown in FIGS. 3A, 3D, and 3E.

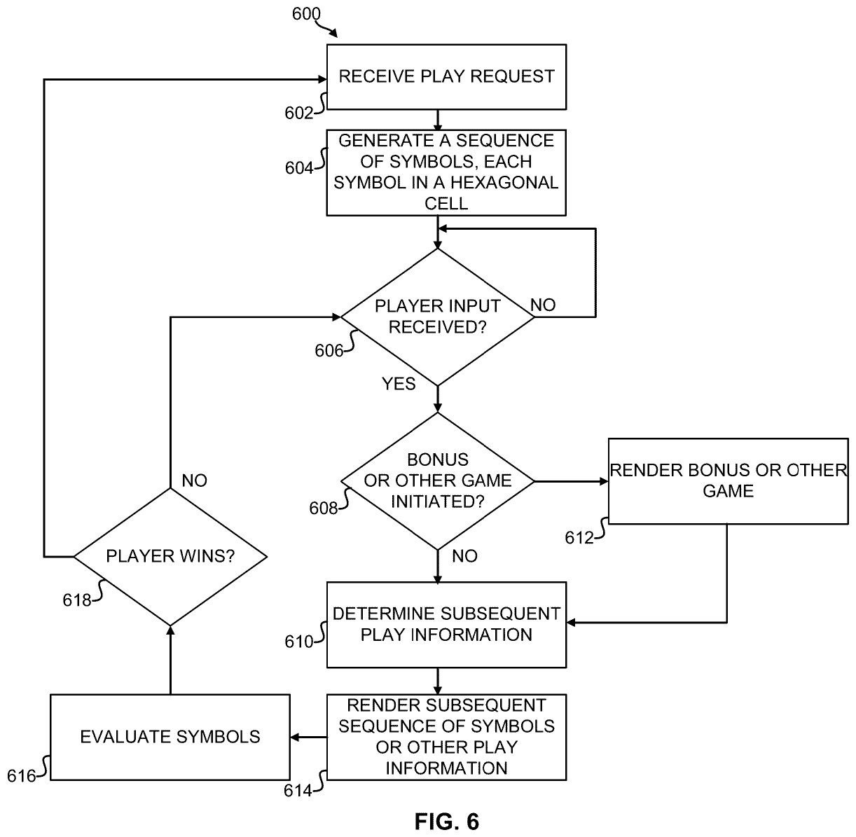

In addition, in some embodiments, such as indicated in FIG. 6, the gaming system or platform 100 (FIG. 2) can include programming or instructions that, when executed, can cause the gaming system or platform to present one or more rounds or play levels of a skill game with different playfield configurations. For example, in embodiments, the player can be given an option to play at a higher level (e.g., by selection of a level, or higher wager amount or value), and if the player elects to do so, the gaming system or platform can create a new, different playfield having a different arrangement of cells and symbols, such as shown in FIGS. 3D and 3E. This can be done, in various embodiments, by adding or removing reels, rows, and/or columns, and, in some instances, adding or removing certain cells of the hexagonal array of cells.

The ability of the gaming system or platform and methods of the present disclosure to utilize a reconfigurable playfield, such as a hexagonal playfield as shown in the drawings, can enable greater variation and levels of play of an electronic game such as a skill game, which can present greater challenges to the skill of players. As a result, the players' interest in playing such skill games can be maintained for longer periods of play. In addition, the reconfigurable playfield further can enable the creation of greater numbers of winning sequences/paylines. For example, players can play a game with a 2×3×2 hexagonal playfield such as shown in FIG. 3A, with the ability to win the game in 7 different ways. If they select to play a more challenging game, the playfield can be rearranged to present, by way of example only, 3×4×3×4×3 array of cells, which is more difficult to solve, but also provides more (e.g., 10) winning sequences or paylines.

During regular play, a “wild symbol” may be selectively played/placed by a player in any hexagonal cell in the array of hexagonal cells of the skill game. The symbol selected as the “wild” symbol may be any symbol displayed in the playfield, and to win the game, should be a particular symbol that the player selects to complete a winning a sequence of symbols as part of an array of hexagonal cells (e.g., where the selection of the “wild” symbol is associated with a particular symbol that creates a best or highest value winning sequence of symbols. In embodiments, all symbols rendered in each of the hexagonal cells in the array of hexagonal cells of the skill game may be selectable to turn them into a “wild” symbol during a play of the skill game; while in some embodiments, fewer symbols within the array of cells may be available to be selected as a “wild’ symbol.

In some embodiments, a “hint” or clue feature can be provided (e.g., via a button on the console or screen of the game), which, if engaged by the player, can provide a hint or clue for solving the game. For example, in embodiments, an indicator such as an identifying mark (e.g., a crosshair type of symbol, highlight, underscore, and/or star) may be rendered along with a particular symbol (e.g., via a display screen of the gaming device). In other embodiments, the indicator could include animation effects such as flashing colors, movement of characters, etc., which may be utilized to indicate a symbol or symbols that can provide a winning combination.

In embodiments, e.g., if a player selects to receive a hint, the indicator can be generated and may indicate a particular play or symbol selection that may result in a win, a partial win, or a move that places a symbol closer to a winning or partial winning position. For example, in embodiments, if the player requests a hint, the indicator could indicate or provide a hint to the player for selection of a symbol that could enable them to win a “small” award with a limited return value that could be equal to or less than the value wagered for the pay of the skill game, but greater that a complete loss. In such instances, the player can still exercise a greater level of skill when playing the game to win a greater/higher value award or prize.

In some embodiments, the gaming system or platform can generate a playfield with a selected arrangement of cells (e.g., a different number of reels defining various offset rows and columns of cells such as shown in FIGS. 3A-3E) of a play of the skill game, which may be determined based on a value/amount of the game by a player, and further, based on the bet amount, can determine a number of plays are available, or offered, to the player. The number of plays may increase when the bet amount is above a predetermined threshold. Additionally, or alternatively, the number of plays may decrease when the bet amount falls below the predetermined threshold. In another embodiment, identifying mark may be removed or disabled for higher bets or may be removed by a player to increase a potential amount won.

In any event, the player may have the ability and choice to select any of the displayed symbols during a play of the skill game to create a winning combination. In some embodiments, the use of a timer can limit the time for the player to exercise judgement or skill to select a “wild” symbol to make a winning sequence (e.g., the shorter the time allotted to win the game, the less time the player has to decide what “wild” symbol to play), thus requiring greater skill to win the game. In other possible embodiments, the number of reels, and thus the number of rows and columns of symbols that can be selected to become the “wild” symbol during each play may depend on whether the player wishes to increase their chances of winning or increase their payout amount (e.g., if the player wants to play for a higher value award, the gaming system can be configured to generate varying playfields with multiple reels (e.g., multiple rows and columns) so as to present a greater number of symbols that a player must choose from to win, though the skill game can also be presented with a greater number of paylines to enable the player to create winning combinations of differing values. For example, playing for a higher value prize can require the player to exercise greater skill to solve the game by recognizing the proper symbols to select as the “wild” symbol to create the best or highest value winning sequence or configuration.

The skill-based amusement system can determine an award for obtainment of a particular matched set or arrangement of a particular symbol within the hexagonal based grid or array of the game being played based on an amount of time remaining on a timer associated with the symbol and/or based on the type of symbol matched (for example, a match of higher value symbols may award more than a match of lower value symbols). In embodiments, the time allotted on the timer can be varied based on a value of the prize(s) to be awarded if the player wins the game. In addition, in embodiments, the game can be configured to permit or provide multiple winning combinations. For example, the skill game can be programmed to allow a player to select tiers, amounts/values, and/or a multiplier of a value they want to play for, and the timer can be adjusted based on such a selection. In embodiments, the higher the tier or value to be won, the less time.

In alternative embodiments, the timer can be replaced with a counter that is not necessarily tied to a specific time increment. For example, in some instances, the counter can correlate to 1 second or more, and each count can be substantially the same increment; while in other cases, the count can be less than 1 second, e.g., where a player selects a higher tier or value, and/or in some embodiments, the time increments per count can get successively smaller as the game progresses, requiring greater skill to win.

The skill game generally requires a player to exercise some level of skill or thought to when selecting a symbol to make it a “wild” symbol to solve a puzzle presented by the skill game and create a winning sequence of aligned or matched symbols. In embodiments, the skill game further can provide the player with multiple opportunities to win by forming and/or creating a winning sequence or matched payline that creates a “best” solution that enables a higher value award to be achieved. Depending on how many symbols the player has to choose from to create such a winning sequence, and, in embodiments, an amount of allotted time to do so, the player can create more than one a winning sequence, with different winning sequences corresponding to different paylines that can provide a higher or lower value. Thus, in embodiments, simply because the player makes a winning combination, even if that is not the “best” or highest value winning combination, the player can still “win the game,” which gives the player some return on the value they have wagered or selected for the play, even though such a win may not be worth more than their wagered amount or value. In some instances, if a best winning sequence is not selected by the player, the instructions run by the gaming system or platform could deem that a losing sequence and no award may be made.

In some embodiments, a programmed set of instructions or rules for play of the game may define game outcomes for symbol types, symbol types in particular sequences or orders, symbol types in particular hexagonal cells in the presentation order of the array of hexagonal cells, and/or the like. If the selected “wild” symbol would correspond to a “cherry” disposed in the final position of a winning sequence of symbols a different winning “wild” symbol may be required for the next play of the game (e.g., no winning sequence of symbols may be maintained from one play to the next.

Among other things, embodiments of the present disclosure provide a player with more ways to win a game, the ability to alter the chances of winning in a game, the ability to alter the payout amount for a winning game outcome (for example, through a bonus round or match), and add excitement to the overall game-playing experience of skill games.

With reference now to FIGS. 1A and 1B, an illustrative gaming system or platform 100 (e.g., comprising a computational device) that may be used to implement a skill game or the like will be described in accordance with at least some embodiments of the present disclosure. A gaming system or platform 100 may include a portable (for example, the device illustrated in FIG. 1B) or non-portable device (for example, the gaming terminal or device illustrated in FIG. 1A) used for executing a gaming application or multiple different gaming applications without departing from the scope of the present disclosure. While one device is described as non-portable, it will be understood that such a device may not be considered fixed, but rather not easily movable, non-limiting examples of a computational device embodied in the gaming system or platform 100 can include an electronic gaming machine (EGM), a Video Gaming Machine (VGM), a mobile communication device (e.g., a smartphone, laptop, tablet, and/or wearable device), and a personal computer (PC). An EGM or VGM-type of gaming system or platform 100 (which can comprise a computational device) is shown in FIG. 1A in accordance with embodiments of the present disclosure.

The illustrative computational device gaming system or platform 100 of FIG. 1A is shown to include a support structure, housing or cabinet, 102 which provides support for a plurality of displays, inputs, controls and other features of a conventional gaming machine. The illustrated gaming system or platform 100 also may be configured as a stand-alone computational device; and can be constructed with varying cabinet and display configurations.

In one embodiment, the gaming system or platform 100 is configured to generate awards and/or other game outcomes based on probability data. In embodiments, the gaming system or platform 100 can generate outcomes based upon various parameters, which can be pre-determined or selected for each game, and can be different for different games, or based on other programmed features, such as generating a probability calculation.

In some embodiments, the gaming system or platform 100 may employ a predetermined or finite set or pool of awards, progressive awards, prizes, or other game outcomes. As each award or other game outcome is provided to the player, the computational device 100 removes the provided award or other game outcome from the predetermined set or pool. Once removed from the set or pool, the specific provided award or other game outcome cannot be provided to the player again. The computational device 100 provides players with all of the available awards or other game outcomes over the course of the play cycle and guarantees a designated number of actual wins and losses.

In addition, in embodiments, the gaming system or platform 100 may include one or more displays 112. An illustrative display 112 may include a credit display that displays a player's current number of credits, cash, account balance or the equivalent. Another illustrative display 112 may include a display that displays a player's play value for the game (e.g., in embodiments, an amount wagered).

In the Figures, the gaming system or platform 100 is also shown to include at least one payment acceptor. Illustrative payment acceptors may include, without limitation, a coin slot 124, where the player inserts coins or tokens, and a ticket, note, or bill acceptor 128, where the player inserts a bar-coded ticket, note, voucher, card, or cash. In one embodiment, a player-tracking card, credit card, debit card, or data card reader/validator 132 is also provided for accepting any of those or other types of cards as a form of payment toward playing a game on the gaming system or platform 100.

In one embodiment, a player can insert cash or a card into a currency acceptor or card reader 132 of gaming system or platform 100, which can generate an amount of credits for play of the skill-game. The identification card can be a smart card having a programmed microchip or a magnetic strip coded with a player's identification, credit totals, and other relevant information. In one embodiment, money may be transferred to the gaming system or platform 100 through an electronic fund transfer and card reader 132 using the player's credit, debit, or smart card. When a player funds the gaming system or platform 100, a processor of the gaming system or platform 100 may determine the amount of funds entered and the corresponding amount is shown on the credit or other suitable display 112 as described above.

In one embodiment, after credits have been input/received, and the player has selected a game play amount, the player can initiate game play, such as by engaging buttons, levers, gesture inputs, and/or other input devices that enable a player to start any game play or sequence of events. In one embodiment, upon appropriate funding, gaming system or platform 100 begins game play automatically. In another embodiment, the player needs to actuate or activate one of the play buttons to initiate play of a game (e.g., a skill-based game) on the gaming system or platform 100. Other non-limiting types of input devices 108 may include a “bet one” button, a “max bet” button, or any other type of button known to be included in an EGM, VGM, or the like.

It should further be appreciated that the input devices 108 may correspond to a physical button, a virtual button on a touchscreen of a game, an input element on a Graphical User Interface (GUI), or a combination thereof. In other words, the input devices 108 do not need to correspond to a physical button. In some embodiments, the player places a bet by pushing a “bet one” button (e.g., betting an amount equal to one credit for the next play). The player may increase the player's wager by one credit each time the player pushes “bet one” button. When the player pushes the “bet one” button, the number of credits shown in the credit display decreases by one, and the number of credits shown in the bet display increases by one. In embodiments, a “max bet” button can also be provided, which enables the player to bet the maximum wager (e.g., max lines, max wager per line, and re-spin operation). The gaming system or platform 100 may include other suitable wager buttons, such as a “repeat bet” button (e.g., repeating the bet made from the immediately last play of the gaming system or platform 100 for the next play of the gaming system or platform 100), one or more “select paylines” buttons, a “select re-spin operation” button, and one or more “select wager per payline” buttons.

Another type of input device 108 that may be provided on the gaming system or platform 100 is a physical “cash out” button, a virtual “cash out” button, a selectable GUI element, or the like. The player presses a cash out button and cashes-out to receive a voucher or other suitable form of receipt corresponding to the number of remaining credits. In embodiments, the player can receive tokens, etc. via a payout tray or a ticket or credit slip, which are redeemable by a cashier or funded to the player's electronically recordable identification card.

The gaming system or platform 100 may also include one or more display screens 104 and one or more sound generating devices 136. The combination of outputs provided on a display screen 104 and sound generating device 136 may contribute to the game play experience and, in some embodiments, may provide the player with information regarding a status of a game play event or sequence of events.

In one embodiment, the sound generating device 136 may include at least one speaker or other type of transducer for generating audible sounds and/or playing music. In one embodiment, a gaming system or platform 100 provides dynamic sounds coupled with attractive multimedia images displayed on the display screen 104 to provide an audio-visual representation or to otherwise display full-motion video with sound to attract players to the gaming system or platform 100. During idle periods, the gaming system or platform 100 can display a sequence of audio and/or visual attraction messages to attract potential players to the gaming system or platform 100.

FIGS. 1A-1B and 3-5A illustrate embodiments of a skill game shown as a hexagonal grid-based game with a hexagonal based array of one or more paylines 120 is shown. For purposes of illustration, the game is shown using a series of numbered cells arranged in a 2×3×2 hexagonal grid or field having 3 adjoining columns of hexagonal cells (with a first column having a 2 adjoining hexagonal cells, a second columns having 3 adjoining hexagonal cells, and a third column having a 2 adjoining hexagonal cells). The cells can include offset or staggered rows and/or columns. It will be understood from the additional illustrated embodiments, that other arrangements and/or symbols also can be used in the hexagonal grid or field.

As will be discussed in further detail herein, the skill game provided by the gaming system or platform 100 may support one or multiple paylines 120, which may extend across the display screen 104 vertically, horizontally along a staggered row, diagonally, and/or at adjusted angles. In some embodiments, such as for a multi-reel game, a payline 120 intersects a plurality of reels or columns 116. Each reel/column 116 of the display screen 104 may be used to display different sets of symbols in connection with game play activity provided by the gaming system or platform 100. In some embodiments, each reel/column 116 may operate independent of all other reels/columns and the symbols displayed by a reel/column 116. The positions of symbols on each reel/column 116 and in the combination of reels/columns 116 may form the array of hexagonal cells in the presentation order rendered to the display screen 104 of the gaming system or platform 100.

The reels/columns 116 may be provided in video form with simulated reels being displayed via the display screen 104. A reel/column 116 may be used to display any number of symbols such as bells, hearts, fruits, numbers, letters, bars or other images and symbols, which preferably correspond to a theme associated with a game provided by the gaming system or platform 100. In embodiments, the gaming system or platform 100 may be configured to award prizes, awards, or other game play opportunities when the reels/columns 116 stop spinning and a predetermined symbol combination lands across an active payline 120 (for example, a payline 120 that is currently being wagered and is subject to evaluation for a win after the reels/columns 116 have stopped spinning).

FIG. 1B illustrates another example of a gaming system or platform 101 in accordance with at least some embodiments of the present disclosure. This particular example of gaming system or platform 101 may correspond to a portable gaming system or platform 101 such as a mobile smartphone, tablet, and/or wearable. The gaming system or platform 101 may be owned by a user of the gaming system or platform 101 rather than being owned by a casino operator.

The gaming system or platform 101 (and, in another example, the gaming system or platform 100) again includes a display screen 105, a plurality of input devices 108, and at least one sound generating device 136 (such as a speaker). In some embodiments, the display screen 105 may correspond to a touch-sensitive display screen, meaning that the display screen 105 is simultaneously capable of displaying information (for example, in connection with game play activity) and receiving a user input (for example, the display screen may act as an input device). In some embodiments, the touch-sensitive display screen 105 may provide game features similar to a cabinet-style computational device 101 without requiring all of the dedicated buttons provided by a cabinet-style computational device 101.

With reference now to FIG. 2, additional details of the components that may be included in a gaming system or platform 100 will be described in accordance with at least some embodiments of the present disclosure. The gaming system or platform 100 is shown to include a processor 204, memory 208, a network interface 212, and a user interface 216. In some embodiments, the processor 204 may correspond to one or many microprocessors, Central Processing Units (CPUs), microcontrollers, Integrated Circuit (IC) chips, or the like. The processor 204 may be configured to execute one or more instruction sets stored in memory 208. In some embodiments, the instruction sets stored in memory 208, when executed by the processor 204, may enable the gaming system or platform 100 to provide game play functionality.

The nature of the network interface 212 may depend upon whether the network interface 212 is provided in cabinet-style gaming system or platform 100 or a mobile/portable gaming system or platform 101. Examples of a suitable network interface 212 include, without limitation, an Ethernet port, a Universal Serial Bus (USB) port, an RS-232 port, an RS-485 port, a network interface controller (NIC), an antenna, a driver circuit, and/or a modulator/demodulator. The network interface 212 may include one or multiple different network interfaces depending upon whether the gaming system or platform 100 is connecting to a single communication network or multiple different types of communication networks. For instance, the gaming system or platform 100 may be provided with both a wired network interface 212 and a wireless network interface 212 without departing from the scope of the present disclosure.

The user interface 216 may include a combination of the user input and user outputs described in connection with FIGS. 1A and 1B. For instance, the user interface 216 may include the display screen 104, the input devices 108, the speakers 136, or any other component that is capable of enabling user interaction with the computational device 100. The user interface 216 may also include one or more drivers for the various hardware components that enable user interaction with the gaming system or platform 100.

The memory 208 may include one or multiple computer memory devices that are volatile or non-volatile. The memory 208 may be configured to store instruction sets that enable player interaction with the gaming system or platform 100 and that enable game play at the gaming system or platform 100. Examples of instruction sets that may be stored in the memory 208 include a game instruction set 220, a credit meter 224, and a “wild” symbol selection instruction set 228. In addition to the instruction sets, the memory 208 may also be configured to store instructions or information such as a payout table or calculator, for example, to provide game outputs.

In some embodiments, the game instruction set 220, when executed by the processor 204, may enable the gaming system or platform 100 to facilitate one or more games of chance or skill and produce interactions between the player and the game of chance or skill. In some embodiments, the game instruction set 220 may include subroutines that present one or more graphics to the player via the user interface 216, subroutines that calculate whether a particular wager has resulted in a win or loss during the game, subroutines for determining payouts for the player in the event of a win, and in some embodiments, subroutines for exchanging communications with another device, such as a server, and subroutines for determining which symbols (if less than all symbols presented) can be selected as a “wild” symbol during game play, and any other subroutine useful in connection with facilitating game play at the gaming system or platform 100.

In some embodiments, the game instruction set 220 may include instructions that initiate generation of a new game and/or game field, which, in some embodiments, could include a spin of various reels/columns 116, or, using an example of balls, racking of the balls and then “breaking” them apart as would be found in a game of billiards, in connection with game play. Other ways of starting/presenting a next game also can be provided. Typically, in embodiments, the game will be presented without a winning combination already having been created-thus requiring the player to use their skill to win the game. The game instruction set 220 may also be configured to present symbols via the display screen 104 when the reels/columns 116 correspond to video reels/columns or the like. The game instruction set 220 may also be configured to evaluate a position of symbols relative to one or more paylines 120, relative to predetermined symbol areas, or hexagonal cells in an array of hexagonal cells, and any other evaluation desired to facilitate game play.

The credit meter 224 may correspond to an instruction set within the gaming system or platform 100 that facilitates a tracking of wager activity at the gaming system or platform 100. In some embodiments, the credit meter 224 may be used to store or log information related to various player activities and events that occur at the gaming system or platform 100. The types of information that may be maintained in the credit meter 224 include, without limitation, player information, available credit information, wager amount information, and other types of information that may or may not need to be recorded for purposes of accounting for wagers placed at the gaming system or platform 100 and payouts made for a player during a game of chance or skill played at the gaming system or platform 100.

In some embodiments, the credit meter 224 may be configured to track coin in activity, coin out activity, coin drop activity, jackpot paid activity, credits applied activity, external bonus payout activity, voucher in activity, voucher out activity, timing of events that occur at the gaming system or platform 100, and the like. In some embodiments, certain portions of the credit meter 224 may be updated in response to outcomes of a game of chance or skill played at the gaming system or platform 100.

In embodiments, a “wild” symbol selection instruction set 228 may correspond to a subroutine that is executed by the processor of the gaming platform executing the game instruction set 220 during game play. In embodiments, the “wild” symbol selection instruction set generally will be configured to enable a player to select a symbol to change to a “wild” symbol in its existing cell.

In addition, in embodiments, the “wild” symbol selection instruction set 228 of the game instruction set 220 can be configured to enable input of a “wild” symbol selection by the player to change a symbol presented in at least one of the cells of the rows and/or columns to a “wild” symbol. For example, for some expanded game fields (e.g., having more than 3 rows and column) such as shown in FIGS. 3D, 3E, and 5, the player could be enabled to select one symbol of those presented as a “wild” symbol to, in effect, change it to a particular symbol that matches other symbols of the array to create at least one winning sequence or payline, such as shown in FIGS. 3C and 3E.

Still further, in some embodiments, the “wild” symbol selection instruction set 228 can be configured, when executed by the processor 204, to prompt a player for a selection of a “wild” symbol that the player may select as a “wild” symbol to form a sequence of aligned same symbols along or across the hexagonal cell array during a game play.

In embodiments, the “wild” symbol selection instruction set 228 may further receive the user input of the selected “wild” symbol, and may be configured to identify whether such a symbol creates at least one winning sequence.

In a further embodiment, the player can be presented with a challenge to win the game (e.g., solve a puzzle) by finding the best or highest value winning combination within a specified time, and once the selected time has lapsed, a determination will be made as to what award, if any, the player has won, which, in embodiments, can include whether the player created at least one winning combination, as well as whether they created a best winning sequence of symbols (e.g., they created an arrangement with the greatest number of matching symbols in the array, such as shown in FIG. 3E) to achieve an award greater. The gaming system or platform can, in embodiments, be configured to present different arrays of reels to create playfields with different arrangements of offset rows and/or columns that further can have different numbers of cells, either by player request, as a presentation of a new game of new level, bonus game, updated versions of the game, or combinations thereof. Thereafter, it can determined if the player won or lost, and if they won, what award or prize was won. The play of the game can then be concluded, and the game field of symbols may be refreshed (e.g., automatically or in response to a request by the player for a new game play).

While shown as separate instruction sets, it should be appreciated that the “wild” symbol selection instruction set 228 may correspond to a subroutine of the game instruction set 220 without departing from the scope of the present disclosure.

The gaming system or platform 100 is further shown to include a ticket issuance device 236, a ticket acceptance device 240, a cash/credit in device 244, and a “cash out” device 238 that can provide the player with a ticket, voucher or other redeemable receipt for their award or remaining credits. The ticket issuance device 236 may be configured to receive physical tickets, vouchers, or player loyalty cards. In some embodiments, the ticket issuance device 236 and ticket acceptance device 240 may operate in concert with the ticket acceptor 128. In such an embodiment, the ticket acceptor 128 may correspond to the physical components that receive and issue a ticket or voucher whereas the ticket issuance device 236 and the ticket acceptance device 240 correspond to the drivers and/or firmware components that control operation of the ticket acceptor 128.

It should also be appreciated that the card reader 132 may be in communication with the ticket issuance device 236 and the ticket acceptance device 140 and may have functionality driven by one or both of these devices. For instance, the card reader 132 may correspond to the physical hardware components that receive information from a player loyalty card (or player loyalty application running on a mobile communication device) and that information may be processed by the ticket acceptance device 240 when receiving player credits from cards read by the card reader 132. The ticket issuance device 236 may provide the card reader 132 with information for applying wager credits back to a player card when a player is done with a game play session and wishes to transfer credits from the credit meter 224 back onto their card. Thus, the ticket issuance device 236 and ticket acceptance device 240 may also operate as a driver and/or firmware component for the card reader 132.

In some embodiments, the cash in device 244 and cash out device 248 may include or operate in concert with the coin slot 124 and any coin delivery mechanisms. The cash in device 244 and cash out device 248 may include hardware, drivers, or firmware that facilitate receiving or distributing cash, tokens, and/or bills. In some embodiments, the cash in device 244 may be configured to determine an amount of cash (for example, in coins and/or bills) and/or an amount or number of tokens input at the coin slot 124 and convert the values into credits for playing games with the game instruction set 220. The cash out device 248 may correspond to hardware and software configured to output coins, tokens, and/or bills if a player decides to cash out or convert playing credits back into coins, tokens and/or bills.

Referring further to the figures, which illustrate in further detail embodiments of a skill game, an illustrative 2×3×2 hexagonal array skill-based game is shown, wherein, in embodiments, a first layout of symbols 318 rendered to an array of hexagonal cells 304 of a skill game will be described in accordance with embodiments of the present disclosure. The array of hexagonal cells 304 may be presented, or otherwise rendered, with the display screen 104. In some embodiments, the game instruction set 220 may control which particular symbols 318 are presented within a particular hexagonal cell 312 in the array of hexagonal cells 304.

In embodiments, the gaming platform can further include one or more processors having programming to enable variations of the game grid or playfield. In an example embodiment, such as shown in FIGS. 3B-3C, an illustrative 2×3×2 array of hexagonal cells 304 is shown to include 3 columns 116a, 116b, and 116c of hexagonal cells 312, with column 116a having 2 hexagonal cells, column 116b having 3 hexagonal cells, and column 116c having two hexagonal cells. In additional embodiments, such as indicated in FIG. 3A such a 2×3×2 array of hexagonal cells 304 can be provided as, for example, an initial configuration of a first or base game. Additional rows and/or columns, and in some embodiments, additional individual cells can be added to provide both greater opportunities to win the game, as well as more winning sequences and better awards.

As shown in FIG. 3A, it therefore will be appreciated that embodiments of the present disclosure can be implemented in an array of hexagonal cells 304 having a variety of sizes, with up to n columns and up to n number of hexagonal cells per column. For instance, embodiments of the present disclosure may be used in an array of hexagonal cells 304 that are 3×4×3, 2×3×4×5, 3×4×3×4×3, 2×3×4×4×3×2, and/or arrays of various other sizes. Still, further it is contemplated that the respective array of hexagonal cells 304 can be modified and/or expanded in the course of game play—such as changing a 3×4×3 hexagonal game array to a 3×4×3×4×3 hexagonal game array. The example layout of the array of hexagonal cells 304 should not be construed as limiting embodiments of the present disclosure.

In embodiments, the gaming platform and terminal can be provided with a plurality of different games that can each have different game grids or field with various arrangements of cells. The game grids do not have to be limited to a particular number of rows or columns, and instead, in embodiments, can be provided with different numbers of rows and columns (e.g., an uneven number of rows and columns).

In some embodiments, the games of the gaming platform or terminal can be configured such that the one or more processors can execute programming or instructions in response to a request or command to change or create a different game grid with different numbers of rows and columns for one or more plays of the game. For example, in some embodiments, if the players requests a higher level or higher value game, the game grid can be varied (e.g., to enable play for higher awards), and in some embodiments, a new, variable game grid or playfield can be generated for a bonus game presented to the player, while in other embodiments, the arrangement of the hexagonal game grid or playfield can be changed to create new versions or as an update to the game.

As can be seen in FIG. 3A, each hexagonal cell 312 in the array of hexagonal cells 304 may be populated with a single symbol 318 (such as, in a non-limiting example, balls, as illustrated). In other words, after the processor executes the game instruction set 220 to determine symbol 318 placement throughout the array of hexagonal cells 304, there will be a 1:1 correlation of symbols 318 to hexagonal cells 312. Each column 116a, 116b, 116c may also be referred to as a reel or column 116, particularly in the event that the game instruction set 220 provides a multi-reel game. In some embodiments, a symbol 318 may correspond to an absence of a symbol or a blank symbol. This blank symbol may correspond to a symbol in a hexagonal cell 312 having no value.

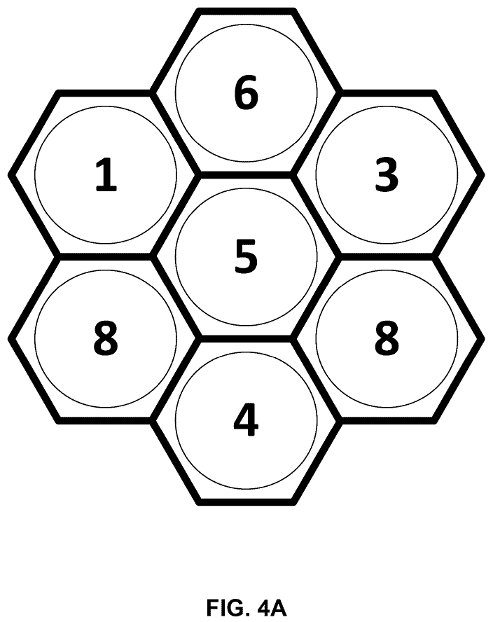

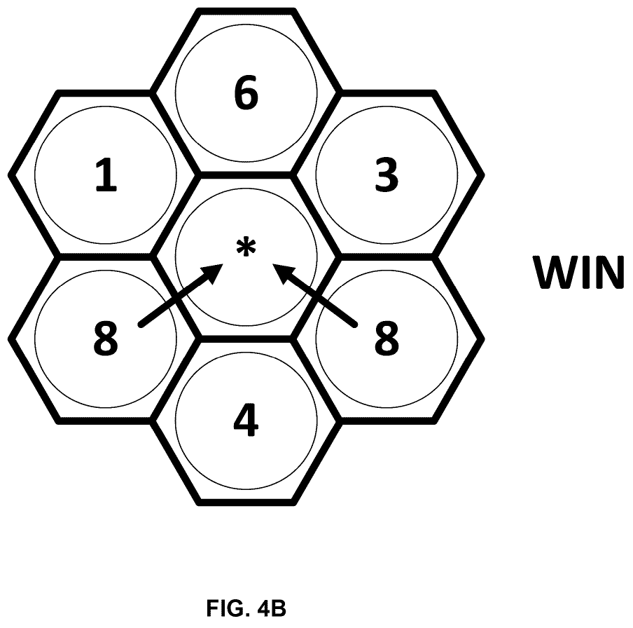

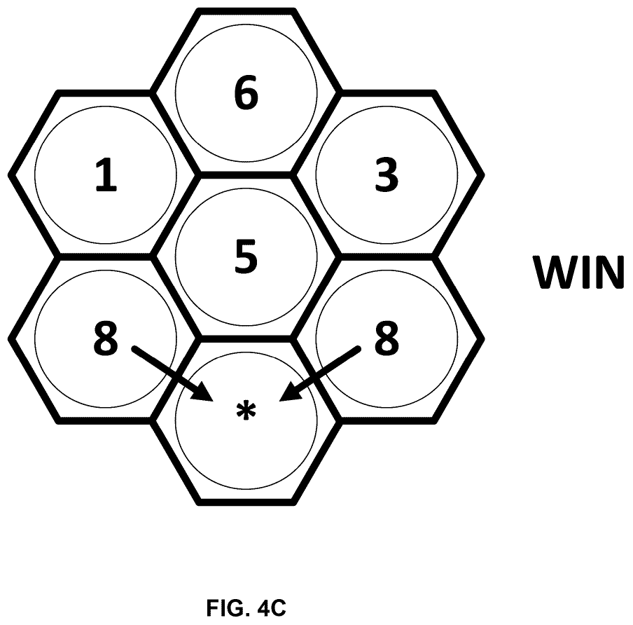

In some embodiments, rewards, prizes, payouts, or other predetermined game outcomes (e.g., bonus spin opportunities, prize wins, cash wins, re-spin bonus plays, or other prizes) may be determined based on a symbol combination that falls on a payline 120 that was subject to a wager prior to the spin. In some embodiments, a plurality of the paylines 120 may be selected for “play” prior to a spin, meaning that any payline 120 selected for “play” will be evaluated for a predetermined symbol combination, or sequence of symbols 318. In another embodiment, a successful or winning sequence may include selection of an appropriate “wild” symbol to create a sequence of matching symbols aligned in a column, staggered row, or diagonally. For example, lining up each 8 ball in FIGS. 3B and 4A-4B may result in a win.

Additionally, or alternatively, the sequence of symbols 318 may include, but are in no way limited to, a sequence of symbols 318 in an order along one or more of the vertical lines of hexagonal cells 312 associated with the columns having at least three stacked hexagonal cells that can be arranged in a staggered configuration so as to be in offset or staggered rows. In some embodiments, the sequence of symbols 318 may include, but are in no way limited to, a sequence of symbols 318 in an order along one or more of the hexagonal cells 312 having a payline 120 running therethrough. In one embodiment, the sequence of symbols may comprise all sequences of symbols associated with each defined hexagonal based array.

An example of an embodiment of various payline layouts based on a 2×3×2 grid of symbols is shown in FIG. 3C. In addition, another example embodiment of a plurality of paylines for such a game is shown in FIG. 3E, for example, for an embodiment of a game with a 3-4-3-4-3 style hexagonal playfield or grid as shown in FIG. 3D.

Although the game grid shown in FIG. 3C illustrates seven different exemplary paylines 120 (e.g., staggered horizontal (4), vertical (1), and/or diagonal (2)), it is contemplated that one or more paylines 120 may be associated with hexagonal cells 312 in any shape the array of hexagonal cells 304. As shown, in one embodiment, a payline 120 may run through a single staggered row of hexagonal cells 304. In some embodiments, a payline 120 may run through one or more columns in the array of hexagonal cells 304. In any event, embodiments of the present disclosure are not limited to the position and/or shape of the paylines 120 shown throughout the figures.

In another non-limiting example, FIG. 3D illustrates ten different exemplary paylines 120. It is contemplated that one or more paylines 120 may be associated with hexagonal cells 312 in any shape the array of hexagonal cells 305. As shown, in one embodiment, a payline 120 may run through a single staggered row of hexagonal cells 305. In some embodiments, a payline 120 may run through one or more columns in the array of hexagonal cells 305 or may run diagonally through staggered and/or adjacent hexagon cells. In any event, embodiments of the present disclosure are not limited to the position and/or shape of the payline 120 shown throughout the figures.

For example, an illustrative game play sequence that can be performed by the game instruction set 220 and the “wild” symbol selection instruction set 228 will be described in accordance with at least some embodiments of the present disclosure. A game begins by pressing PLAY, which may be a hardware or on-screen software button. After pressing PLAY (which can include selecting a number of credits for the game—the more credits, the greater a potential prize to be awarded), the symbols animate to form a non-winning pattern. As such, no consecutive matching symbols exist to automatically create a winner on any pay-line.

In this example, the original play, or spin, and placement of symbols 318 throughout the array of hexagonal cells 304 may have been determined by the game instruction set 220. Stated another way, each hexagonal cell 312 in the array of hexagonal cells 304 is populated with a respective discrete symbol 318 that is rendered by the display screen 104 of the gaming system or platform 100. The symbols 318 further generally may appear to be randomly assigned to each hexagonal cell 312 in the array of hexagonal cells 304.

In embodiments, the position of symbols 318 in the array of hexagonal cells 304 may be evaluated by the game instruction set 220 to determine if a predetermined game outcome has occurred (e.g., a wager has resulted in a win or prize). For instance, the game instruction set 220 may determine if a sequence of symbols 318 along a payline 120 corresponds to a winning game outcome. The sequence of symbols 318 may correspond to an order of symbols 318 in a particular sequence as defined by the rules of the game. In one embodiment, and depending on the rules of the game, these symbols 318 may be required to be the same, for example, forming a match between two or more hexagonal cells 312 in the sequence of symbols 318.

In some embodiments, the placement and position, or hexagonal cell 312, associated with a best selection of a “wild” symbol in the array of hexagonal cells 304 may be determined (e.g., via the game instruction set 220 and/or the “wild” symbol selection instruction set 228 executing instructions). As provided above, the best selected “wild” symbol may correspond to any type of particular symbol 318 used in the game. In one embodiment, the best selected “wild” symbol may correspond to a bonus symbol type, a high-probability winning symbol type (e.g., cherries, diamonds, and/or multipliers), and/or some other symbol that may increase the player's chances of winning on a subsequent play where the selected “wild” symbol is maintained in a particular hexagonal cell 312 in the array of hexagonal cells 304.

During play of the game, the player generally is required to make at least one “wild” symbol selection to solve/win the game. Typically, the player will be allowed to make one selection of a “wild” symbol and upon doing so, completes a play of the game.

In some embodiments, the position of the hexagonal cell 312 in which the “wild” symbol was selected may determine whether a behavior of the game should be altered. Game behavior may include proposed payout amounts, odds or chances of winning, and/or additional wagers required; modification in the size of the hexagonal game grid size and/or shape, and the like.

In a further embodiment, and as shown in FIG. 5, if a player elects to try for an additional challenge, the gaming system can be configured to add hexagonal cells 312 to the hexagonal grid array. Thus, in this embodiment, the game can move or be changed/reconfigured from an exemplary 2×3×2 hexagonal grid array to an exemplary 3×4×3×4×3 hexagonal grid array that increases the challenge to the player while increasing the potential winning payout for solving the larger, more challenging hexagonal grid array according to the rules of the particular game being played.

In addition, in embodiments, a timer can be activated and begin a countdown. The player then has a preset time to select a symbol to turn it into a “wild” symbol to solve and win the game before time expires. Embodiments of the method for manipulating the symbols could vary by game. After achieving the best possible symbol alignment, the game completes, at which point, the game controller or processor can evaluate the onscreen symbols to determine any winning amount. The game will reward the player if the selected winning symbols or a pattern thereof are placed on one or more paylines or if the symbols or patterns thereof are fully completed, as several patterns to partially solve/win the game may exist.

In embodiments, the timer can be adjusted based on a reward selected by the player. For example, if a player selects a prize with a higher value or decides to wager a higher amount of credits for a higher RTP (e.g., to gain a return of a greater number of credits), then the timer may decrease.

FIG. 5 illustrates a bonus stage based on a matching of selected symbols. Once the selected symbols are aligned, the display may be transitioned to a bonus stage. Such a stage may, as a non-limiting example, include a score multiplier. Optionally, in the bonus stage, the game can add hexagonal cells 312 to the hexagonal grid array, e.g., moving from an exemplary 2×3×2 hexagonal grid array to an exemplary 3×4×3×4×3 hexagonal grid array 304 to increase the challenge to the player while increasing the potential winning payout for solving the larger, more challenging hexagonal grid array according to the rules of the particular game being played.

With reference now to FIG. 6, a flow diagram depicting a method 600 of an example process for enabling the gaming system to reconfigure the playfield is shown in accordance with embodiments of the present disclosure. The method 600 described herein may be run as a set of instructions on a gaming system or platform 100 and/or some other server in communication with the gaming system or platform 100. In some embodiments, the set of instructions may be part of an application installed on the gaming system or platform 100.

In embodiments, the method can include initiating game play by receiving a play request initiating a play of a skill game (step 602). This step may occur in response to the player selecting a predetermined button or providing an input via some other input device 108, inserting coins, cash, tickets, and/or vouchers or performing some other action at the gaming system or platform 100 that indicates a desire to begin game play.

In one embodiment, the play request may correspond to an input requesting a play of the game provided by the player via an input device 108. For example, the first input may correspond to a button press, a touch of a screen, a lever actuation, a gesture, and/or some other physical input provided by the player. In embodiments, a game will be displayed, rendered, or generated (step 604), and in some embodiments, can comprise a skill game with a game field having a series of rows and columns. In embodiments, the skill game may correspond to a reel-spin game, a matching game, and/or any other game having a sequence of symbols 318 arranged in a presentation order. For example, the game may include a sequence of symbols, each symbol in the sequence positioned within a hexagonal cell. The cells may be arranged in a series of rows and/or columns. Each symbol may be selectable via the user.

The game instruction set 220 may wait for a player input (step 606) (for example, selection of a symbol to cause that symbol to change to a different symbol, such as a number to a “wild” character or a “*”, or, in another example, selection of a new game or a bonus game). In response to receiving the player input, the game instruction set, may determine whether the player input corresponds to selection of a bonus game or another game (step 608). If the selection is a bonus game or another game, then the game instruction set 220 may render the bonus game or another game (step 612) and continue with the method as described below. If the player input is selection of a symbol, the method continues by determining subsequent play information (step 610).

Subsequent play information may include determining which symbol has been selected and then converting into a “wild” or “*” symbol. In another embodiment, a different symbol may be utilized when a player selects a symbol, for example, a first type of symbol may change into a second or different type of symbol or a different first type of symbol. The game instruction set 220 may then render the subsequent sequence of symbols or other play information (step 614). The game instruction set 220 may then evaluate the symbols to determine whether the player input has resulted in a win (step 616). If the player wins (step 618), then the game instructions set 602 may generate a pay out or value for the win and then wait until a next play request is received. If the player does not win, then, in an embodiment, the game instruction set 220 may wait for a next player input, such as a next or second play request to play the game again (at step 606). In another embodiment, if the player does not win, the game may end, and the game instruction set 220 may wait until a next play request.

In another embodiment, game play generally proceeds when a “wild” symbol selection input is received by the player selecting a particular symbol from one hexagonal cell 312 in the array of hexagonal cells 304 to turn that symbol into a “wild” symbol or replace the symbol in the cell with a “wild” symbol. The player interacting with the gaming system or platform 100 may select the particular symbol 318 in the rendered first sequence of symbols to identify it as a “wild” symbol to create a pattern or sequence of same symbols (including the “wild” symbol) in the array of hexagonal cells 304. Thereafter, the gaming system or platform, executing the game instruction set, will determine if a winning sequence has been made (e.g., a solution to the puzzle has been achieved).

In another example, in embodiments, the game instruction set 220 may instruct the gaming system to evaluate positions of the symbols 318, including the new, selected “wild” symbol laid out in the array of hexagonal cells 304 to determine if one or more winning sequences are created. The evaluation of symbols 318 may include determining which paylines 120 will be subject to evaluation and whether any of the selected paylines 120 have a predetermined combination of symbols 318 provided thereon. In some embodiments, the evaluation of the symbols may comprise determining, based on a position of the particular symbols matched with the selected “wild and a position thereof, what particular payline 120 or a plurality of paylines 120 are matched by such symbols to determine if the subsequent play resulted in a winning game outcome. This winning game outcome may include winning a prize, winning playing credit, winning money, winning a bonus spin, and/or achieving a game achievement. Thereafter, the game play can be concluded.

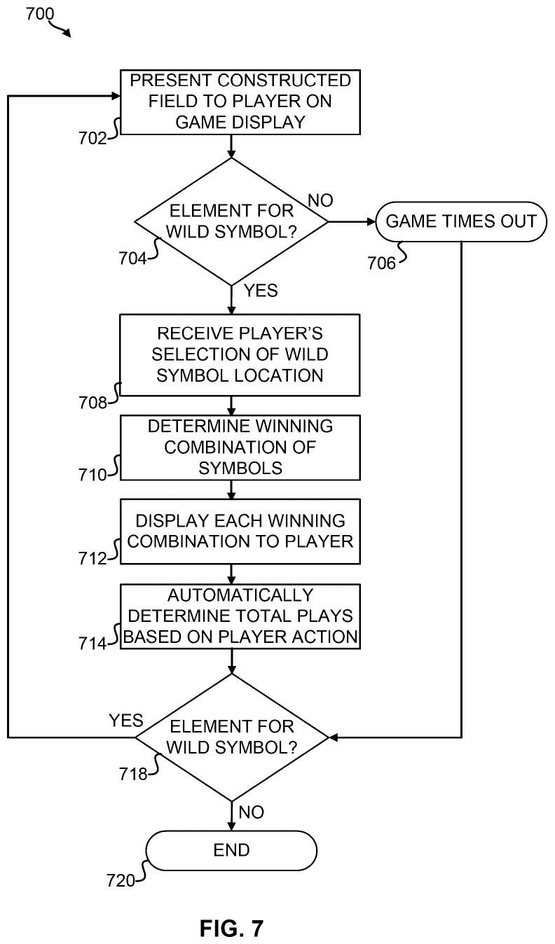

FIG. 7 is a flow diagram of an example process for performing a play operation in the skill game. The method 700 described herein may be run as a set of instructions on a gaming system or platform 100 and/or some other server in communication with the gaming system or platform 100. In some embodiments, the set of instructions may be part of an application installed on the gaming system or platform 100.

In the example embodiment of the method 700 illustrated in FIG. 7, the method 700 may include presenting an initial or first constructed game field or playfield to a player on a game display (step 702). The playfield may include a number of hexagonal or other shaped cells. Each cell may include a symbol (e.g., a discrete symbol such as a character, number, shape, etc.), but will not include a “wild” symbol, presented in a first or initial sequence of symbols within the cells of a hexagonal array of cells. A “wild” symbol may be represented by a different type of symbol, for example, an asterisk when the other symbols are numbers or a number when the other symbols are letters, among other examples.

In embodiments, the method 700 further may include determining whether any of the elements or symbols include a “wild” symbol (step 704) in any cell of the initial or first constructed playfield (e.g., the method run by the gaming system or platform will review the initial or first constructed playfield generated for a play of the skill game to ensure that a “wild” symbol is not included in the array of cells). In addition, in embodiments, the method run by the gaming system or platform further can review the initial or first constructed playfield generated for a play of the skill game to ensure that no winning sequence or combination of symbols is already present in the first sequence of symbols presented by the initial or first constructed playfield. If a “wild” symbol is included in the initial or first constructed playfield, and, if, in embodiments, the initial or first constructed playfield includes a winning combination as presented, then the method may include timing out or resetting the game or ending the game (step 706). In such instances, the method also could include notifying an owner, operator, distributor or service tech of a fault condition existing with the gamming system or platform.

The method 700 may then include, receiving a player's selection of the “wild” symbol location (step 708). In other words, the player may be prompted to select a cell to change the existing symbol of that cell to the “wild” symbol to create a player selected sequence of symbols to, potentially, form a winning sequence or combination of same type symbols (including the “wild” symbol) corresponding to at least one payline of the game. The method 700 will then determine whether, after player input, the player selected sequence of symbols shown in the playfield includes a winning combination of symbols (step 710).

If the player selected sequence of symbols is determined to include a winning combination, the method 700 may include determining a value of the winning combination created by the player selected sequence of symbols (step 712). For example, in embodiments, as shown in FIGS. 3C and 3E, the game will include multiple different paylines such that the player can form multiple different winning sequences or combinations to win the game; and in some embodiments, the different potential winning sequences or combinations may have different values, and depending on what winning sequence or combination was created by the payer selected sequence, the player could be awarded a different value prize (e.g., a max value prize where the value is greater than the amount wagered by the player, various lower value prizes, including values equal to or less than the amount wagered, or a full loss of the amount wagered). The gaming system or platform and the method executed thereby could, in embodiments, compare the player selected sequence to the winning sequences or combinations and award a prize value according to which winning sequence or combination is matched.

In embodiments, if a prize has been won by the player, the player will be awarded a prize based on a value of the winning sequence or combination achieved (step 714). In addition, in some embodiments, the method can further include displaying each of the winning combinations or paylines that could have been made to the player. Thereafter, in embodiment, the method 700 also could be configured or operate to determine a number of plays of the game that may remain left based on, for example, an amount of credits the player has obtained or paid for). The method 700 may then check for a next play request from the player (step 718), and if none has been received or if the player has elected to cash-out, then the game may end (step 720), and any remaining credits returned to the player. Also, in some embodiments, the method could be configured to time out the game if the player has not requested a new game, and can refund remaining credits to the player (e.g., by a voucher, return to a ply card, etc.), or take other actions.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards. In some embodiments, the EGM could comprise, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

Various aspects of the present disclosure may include, without limitation, the following:

1. A method comprising:
receiving, by a processor of a gaming device, a play request from a player interacting with the gaming device;
in response to the play request, initiating a first play of a skill-based game by the gaming device, including:
   generating a game field of the skill-based game arranged as an array of cells having a plurality of rows and columns, wherein the cells of the rows and columns are presented in a staggered arrangement;
displaying on a display of the gaming device a first sequence of symbols within the array of cells, each cell in the array of cells comprising a discrete symbol in the first sequence of symbols;
receiving, via a user interface of the gaming device, a symbol movement input from the player interacting with the gaming device to change at least one selected symbol rendered in the first sequence of symbols to a “wild” symbol to create a player selected sequence of symbols;
determining, by the processor of the gaming device, an outcome of the play of the skill-based game has been achieved by comparing the player selected sequence of symbols to at least one winning sequence of symbols for the play of the skill-based game;
wherein the skill-based game is configured to enable creation of multiple varying game fields having different numbers and arrangements of rows and columns of cells.

2. The method of aspect 1, wherein the cells each comprise a hexagonal configuration; and wherein a different number of offset rows and columns of cells can be selected by the processor so as to enable presentation of the skill-based game with arrays having different numbers and arrangements of the cells to provide multiple winning sequences for a play of the skill-based game.

3. The method of aspect 1, wherein the outcome of the first play is further based on a position of the selected “wild” symbol and a position of other symbols of the player selected sequence of symbols relative to the at least one winning sequence.

4. The method of aspect 1, wherein the skill-based game is configured to enable multiple winning sequences; and wherein the outcome comprises one or more different win values or a loss.

5. The method of aspect 4, wherein the win values are based on a ranking of the winning sequences; and wherein one or more of the win values exceeds a play amount of the skill-based game.

6. The method of aspect 1, wherein the outcome is further based on a completion time of the first play.

7. The method of aspect 1, wherein the at least one winning sequence of symbols comprises one or more fully complete winning sequences or partially complete winning sequences.

8. The method of aspect 1, further comprising:
receiving, via the user interface of the gaming device, a second input from the player interacting with the gaming device to initiate a next play of the skill-based game;
rendering, by a display device of the gaming device in response to receiving the second input, a second sequence of symbols populated into an array of cells;
wherein the cells comprise hexagonal cells;
receiving input a player selection of a second selected symbol to be changed to a “wild” symbol in the second sequence of symbols to form a second player selected sequence; and
determining, by the processor of the gaming device based on a position of a plurality of same symbols and the “wild” symbol a game outcome of the next play of the skill game.

9. The method of aspect 1, wherein each symbol of the first sequence of symbols comprises a discrete symbol that deviates from each other symbol of the first sequence of symbols.

10. The method of aspect 1, wherein each symbol of the first sequence of symbols comprises (a) one of one or more shapes, (b) one of one or more colors, and (c) one of one or more sizes.

11. A system comprising:
a user interface including a display and an input device;
a processor; and
a computer-readable storage medium, coupled with the processor, storing instructions executable by the processor that, when executed by the processor, cause the processor to:
   receiving a play request from a player to initiate a play of a skill-based game,
   in response to receiving the play request via the input device, generating a game field to be displayed on the display;
   wherein the game field includes a first sequence of symbols presented as an array of hexagonal cells, each hexagonal cell in the array of hexagonal cells comprising a symbol of the first sequence of symbols,
   receive a player selection of a symbol of the first sequence of symbols to be a “wild” symbol via the input device to create a player selected sequence of symbols including the “wild” symbol,
   based on a position of the “wild” symbol in a selected cell of the array of cells and a position of one or more additional symbols of a same type, determine a game outcome of the play of the skill game;
   wherein the game outcome is determined by whether the positions of the “wild” symbol and the one or more additional symbols of the same type complete at least one winning sequence of adjacent multiple symbols of the same type and the “wild” symbol extending across the array;
   wherein the array of cells comprises at least two offset rows and at least two columns of cells; and
   wherein the array of cells is variable and the instructions are configured to enable the processor to add or delete one or more cells of the array of cells to create different playfields having different numbers of winning sequences for a play of the skill game.

12. The system of aspect 11, wherein the computer-readable storage medium further includes instructions to render the game field on the display.

13. The system of aspect 11, wherein the input device comprises one or more of a touchscreen, virtual buttons displayed on a touchscreen, physical buttons, a directional pad, levers, or joysticks.

14. The system of aspect 11, further comprising a housing, wherein the user interface, processor, and computer-readable storage medium are positioned within or partially within the housing.

15. The system of aspect 14, wherein the housing comprises one of an electronic gaming machine (EGM), a Video Gaming Machine (VGM), a mobile communication device, or a personal computer.

16. The system of aspect 11, wherein first sequence comprises a pattern of symbols that includes one or more complete solutions and one or more partial solutions to the skill game.

17. The system of aspect 16, wherein the one or more complete solutions indicate a high-level win and the one or more partial solutions indicate a low-level win.

18. An apparatus configured for operation of an electronic skill-based game, the apparatus comprising:
a processor; and
a memory coupled with and readable by the processor and storing therein instructions that, when executed by the processor, cause the processor to:
receive a play request from a player to initiate at least one play of the skill-based game;
render, in response to receiving the play request, a playfield on a display, the game field having an array of cells including a first sequence of symbols arranged within the cells of the array of cells;
wherein the array of cells comprises at least two offset rows and at least three columns of cells;
   receive a symbol selection input by the player selecting at least one symbol of the first sequence of symbols and changing a player selected symbol to a “wild” symbol so as to create a player selected sequence of symbols including the “wild” symbol within the array of cells; and
   halting the play of the skill-based game after one or more of (a) the selection of a symbol to be changed to a “wild” symbol has been received, or (b) a selected time for the play of the skill-based game has lapsed;
   determine a game outcome of the play of the skill game based on a position of each symbol and the wild symbol in the player selected of symbols relative to a plurality of winning sequences; and
   wherein one or more of the plurality of winning sequences have different prize values obtainable by the player based on a final arrangement of the symbols in the player selected of symbols.

19. The apparatus of aspect 18, wherein the array of cells is variable; and wherein the processor further includes instructions configured to generate variable game fields for the skill-based game including arrays of different numbers of rows and columns of cells in a staggered arrangement.

20. The apparatus of aspect 18, wherein the outcome of the play of the skill-based game comprises one or more different win values or a loss.

In various embodiments, the gaming system of the present disclosure can include: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines (EGM), and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or j) a plurality of central servers, central controllers, or remote hosts in combination with one another.

A central server, central controller, or remote host and an EGM (or personal gaming device) can be configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a hexagonal cellular network or mobile Internet network), or any other suitable medium. The expansion in the quantity of computing devices and the quantity and speed of internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciates by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, and/or micro-code) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, or any suitable combination of the foregoing.

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The present disclosure has been described herein in terms of examples that illustrate principles and aspects of the present disclosure. The skilled artisan will understand, however, that a wide gamut of additions, deletions, and modifications, both subtle and gross, may be made to the presented examples without departing from the spirit and scope of the present disclosure.

We claim:

1. A method comprising:
receiving, by a processor of a gaming device, a play request from a player interacting with the gaming device;
in response to the play request, initiating a first play of a skill-based game by the gaming device, including:
generating a game field of the skill-based game arranged as an array of cells having a plurality of rows and columns, wherein the cells of the rows and columns are presented in a staggered arrangement; and
displaying on a display of the gaming device a first sequence of symbols within the array of cells, each cell in the array of cells comprising a discrete symbol in the first sequence of symbols;
receiving, via a user interface of the gaming device, a symbol selection input from the player interacting with the gaming device to select at least one symbol rendered in the first sequence of symbols to become a “wild” symbol so as to create a player selected sequence of symbols;
determining, by the processor of the gaming device, an outcome of the play of the skill-based game based upon an alignment of a plurality of same type symbols and the wild symbol of the player selected sequence of symbols in adjacent cells of the array in comparison to at least one winning sequence; and
wherein the skill-based game is configured to enable creation of multiple varying game fields having different numbers and arrangements of rows and columns of cells.

2. The method of claim 1, wherein the cells each comprise a hexagonal configuration; and wherein a different number of offset rows and columns of cells are selected by the processor so as to enable presentation of the skill-based game with arrays having different numbers and arrangements of the cells to provide multiple winning sequences for a play of the skill-based game.

3. The method of claim 1, wherein the skill-based game is configured to enable multiple winning sequences; and wherein the outcome comprises one or more different win values or a loss.

4. The method of claim 3, wherein the win values are based on a ranking of the winning sequences; and wherein one or more of the win values exceeds a play amount of the skill-based game.

5. The method of claim 1, wherein the outcome is further based on a completion time of the first play.

6. The method of claim 1, wherein the at least one winning sequence comprises one or more of fully complete winning sequences or partially complete winning sequences.

7. The method of claim 1, wherein determining the outcome of a play comprises comparing the player selected sequence of symbols to a plurality of winning sequences corresponding to a plurality of paylines and determining a prize award based on whether the player selected sequence of symbols matches any of the plurality of winning sequences.

8. The method of claim 7, wherein if the player selected sequence of symbols matches at least one of the plurality of winning sequences, determining by the processor of the gaming device, a prize award having a win value based upon a priority or ranking of the winning sequences matched by the player selected sequence of symbols.

9. The method of claim 1, wherein each symbol of the first sequence of symbols comprises (a) one of one or more shapes, (b) one of one or more colors, and (c) one of one or more sizes.

10. A system comprising:
a user interface including a display and an input device;
a processor; and
a computer-readable storage medium, coupled with the processor, storing instructions executable by the processor that, when executed by the processor, cause the processor to:
receiving a play request from a player to initiate a play of a skill-based game,
in response to receiving the play request via the input device, generating a game field to be displayed on the display;
wherein the game field includes a first sequence of symbols presented as an array of hexagonal cells, each hexagonal cell in the array of hexagonal cells comprising a symbol of the first sequence of symbols;
wherein the array of hexagonal cells comprises at least two offset rows and at least two columns of hexagonal cells configured to be arranged in side-to-side contact; and
receive a symbol selection input from the player via the input device;
wherein the symbol selection input comprises a selection of a cell of the array of hexagonal cells for placement of a “wild” symbol;
based on a position of the “wild” symbol in a selected cell of the array of hexagonal cells and a position of one or more additional symbols of a same type within the array of cells, determine a game outcome of the play of the skill game;
wherein the game outcome is determined by whether placement of the “wild” symbol in the selected cell completes at least one winning sequence of adjacent same type symbols and the “wild” symbol within the array of hexagonal cells; and
wherein the array of hexagonal cells is variable and the instructions are configured to enable the processor to add or delete one or more cells to the array of cells to create different playfields having different numbers of winning sequences for the play of the skill game.

11. The system of claim 10, wherein the computer-readable storage medium further includes instructions to render the game field on the display.

12. The system of claim 11, wherein the input device comprises one or more of a touchscreen, virtual buttons displayed on a touchscreen, physical buttons, a directional pad, levers, or joysticks.

13. The system of claim 11, further comprising a housing, wherein the user interface, processor, and computer-readable storage medium are positioned within or partially within the housing.

14. The system of claim 13, wherein the housing comprises one of an electronic gaming machine (EGM), a Video Gaming Machine (VGM), a mobile communication device, or a personal computer.

15. The system of claim 11, wherein the outcome of the play is determined by comparing a player selected sequence of symbols to a plurality of winning sequences corresponding to a plurality of paylines and determining a prize award based on whether the player selected sequence of symbols matches any of the winning sequences.

16. The system of claim 11, wherein if a player selected sequence matches the at least one winning sequence, the processor is configured to determine a win value of the at least one wining sequence matched by the player selected sequence based on a ranking of the winning sequences; wherein the outcome comprises a plurality of win value; and wherein one or more of the win values exceeds a play amount of the skill-based game.

17. An apparatus configured for operation of a skill game, the apparatus comprising:
a processor; and
a memory coupled with and readable by the processor and storing therein instructions that, when executed by the processor, cause the processor to:
receive a play request from a player to initiate at least one play of the skill game;
render, in response to receiving the play request, a game field on a display, the game field having an array of cells including a first sequence of symbols arranged within the cells of the array of cells;
wherein the array of cells comprises at least three columns of cells and at least two rows of cells, with each cell of each row of cells being offset from an adjacent cell of the row of cells;
receive a symbol selection input by the player selecting at least one symbol of the first sequence of symbols and changing the at least one symbol from an initial symbol to a “wild” symbol so as to create a player selected sequence of symbols including the “wild” symbol within the array of cells;
halting the play of the skill game after one or more of (a) the selection of a symbol to be changed to a “wild” symbol has been received, or (b) a selected time for the play of the skill game has lapsed;
determine a game outcome of the play of the skill game based on a position of each symbol and the wild symbol in the player selected of symbols relative to a plurality of winning sequences; and
wherein one or more of the plurality of winning sequences have different prize values obtainable by the player based on a final arrangement of the symbols in the player selected of symbols.

18. The apparatus of claim 17, wherein the array of cells is variable; and wherein the processor further includes instructions configured to generate variable game fields for the skill game including arrays of different numbers of rows and columns of cells in a staggered arrangement.

19. The apparatus of claim 17, wherein the outcome of the play of the skill game comprises one or more different win values or a loss.

20. The apparatus of claim 19, wherein the win values are based on a ranking of the winning sequences; and wherein one or more of the win values exceeds a play amount of the skill game submitted by the player for the play of the skill game.
